(19) United States
(12) Patent Application Publication
(10) Pub. No.: US 2025/0025940 A1
(43) Pub. Date: Jan. 23, 2025

(54) DEPOSITION OF SOLID-METAL VOXELS

(71) Applicants: Keng Hsu, Louisville, KY (US); Anagh Deshpande, Louisville, KY (US)

(72) Inventors: Keng Hsu, Louisville, KY (US); Anagh Deshpande, Louisville, KY (US)

(21) Appl. No.: 18/714,895

(22) PCT Filed: Dec. 1, 2022
(86) PCT No.: PCT/US2022/051558

§ 371 Date: May 30, 2024

Related U.S. Application Data
(60) Provisional application No. 63/307,197, filed on Feb. 7, 2022.
(60) Provisional application No. 63/289,999, filed on Dec. 15, 2021.
(60) Provisional application No. 63/284,735, filed on Dec. 1, 2021.

(51) Int. Cl. B22F 10/22; B22F 12/50; B23K 9/04; B23K 11/00; B33Y 10/00; B33Y 30/00; B33Y 40/20

(52) U.S. Cl. CPC B22F 10/22; B22F 12/50; B23K 9/04; B23K 11/0013; B22F 2203/11; B33Y 10/00; B33Y 30/00; B33Y 40/20

(57) ABSTRACT

Various embodiments include an acoustic-energy deposition system that includes at least one Directed Acoustic Energy Deposition (DAED) tool configured to apply acoustic energy to feedstock material in at least one of three vibrational modes and apply intermittent material-tool contact to allow continuous deposition; and a drive system to move the DAED tool in at least one of three-coordinate positions. In various examples, the acoustic-energy deposition and repair system further includes at least one in-situ metrology tool mounted proximal to the DAED tool to measure a grain size of deposited material. Other methods, devices, apparatuses, and systems are disclosed.

### CLAIM OF PRIORITY

This patent application claims the benefit of priority from U.S. Provisional Patent Application Ser. No. 63/284,735, filed on 1 Dec. 2021, and entitled “INTERMITTENT MATERIAL-TOOL INTERACTION CONTROL ENABLING CONTINUOUS DEPOSITION OF SOLID METAL VOXELS USING LOCAL HIGH-FREQUENCY, SMALL-DISPLACEMENT OSCILLATORY STRAIN ENERGY”; U.S. Provisional Patent Application Ser. No. 63/289,999, filed on 15 Dec. 2021, and entitled, “TOOL-MATERIAL ENERGY TRANSFER CONTROL IN HIGH-FREQUENCY, OSCILLATORY STRAIN-BASED MATERIAL DEPOSITION AND JOINING PROCESS FOR CONTROL”; and U.S. Provisional Patent Application Ser. No. 63/307,197, filed on 7 Feb. 2022, and entitled “THROUGH-THE-END-EFFECTOR FEEDSTOCK ROUTING FOR ACOUSTIC ENERGY-ENABLED MATERIAL DEPOSITION”; each of which is incorporated by reference herein in its entirety.

### TECHNICAL FIELD

The subject matter disclosed herein relates generally to systems and methods for additive-manufacturing techniques. In particular, the disclosed subject matter relates to systems and methods for introducing intermittent material-tool contact to allow continuous deposition of material voxels in solid state from a wire feedstock in an additive-manufacturing process.

### BACKGROUND

In contemporaneous additive-manufacturing approaches that use a depositing nozzle or depositing tool, when a layer of material is being deposited, the nozzle or tool follows a continuous path while maintaining a constant distance with a substrate or an existing layer. The nozzle or tool travels in the build-direction (e.g., the z-direction in a three-axis 3D printing), or in a direction not necessarily in the z-direction but substantially orthogonal to an existing layer (in multi-axis printing) only when: (1) a movement to the next layer is needed; or (2) non-deposition moves are being made by the tool, typically to avoid collision with the material that has already been deposited. The resulting path of a constant stand-off height from an existing surface followed by the nozzle or tool does not allow for voxel-by-voxel material deposition-based additive manufacturing using local high-frequency, small-displacement oscillatory strain energy, or other contact-based additive-manufacturing processes.

In additive-manufacturing processes where local high-frequency (e.g., from about 1 kHz to about 1 MHz), small displacement (e.g., from about 0.1 micron to about 100 microns) oscillatory strain-energy is used, the strain energy induced by the linear oscillatory movements in the tool, which is in direct contact with the material to be deposited, transfers the kinetic energy into the material in the form of oscillatory strain-energy in the voxel of material in direct contact with the tool. This strain energy enables the forming of this voxel into the desired shape and the enhanced diffusion of material across the interface with the material voxel and its adjacent surfaces to establish joining.

In order to transfer efficiently the oscillatory movement of the nozzle or tool into the material voxel as oscillatory strain-energy, the nozzle or tool generally has to maintain sufficient physical-contact with the material during the deposition of a voxel. This tool-material contact, however, also introduces a linear frictional-component force along the direction in which the tool travels continuously during printing. This frictional force transfers into the material as a linear strain along the direction in which the tool travels. This additional linear strain causes the material voxel to deform in directions both parallel with and perpendicular to the direction in which the nozzle or tool travels. This deformation results in the fracture of voxel material below the nozzle or tool.

Consequently, additive-manufacturing approaches suffer from various drawbacks, as at least partially outlined above. Accordingly, improved additive-manufacturing systems, methods, and techniques remain desirable.

The information described in this section is given to provide the skilled artisan a context for the following disclosed subject matter and should not be considered as admitted prior art.

### SUMMARY

This document describes, among other things, various types of techniques, methods, and mechanisms to deposit solid-metal voxels by acoustic-energy deposition processes disclosed herein. The voxels are formed in solid state from a wire feedstock in an additive manufacturing process. Further, various embodiments of exemplary intermittent material-tool contact patterns are disclosed. The contact patterns may be used to produce continuous voxel-by-voxel depositions, while reducing or eliminating linear frictional component forces that can produce linear strain within the voxels.

Various methods and techniques, such as the exemplary intermittent material-tool contact method disclosed herein, helps to isolate and reduce or eliminate linear strain in the voxel along a direction of tool travel during a voxel-deposition step. Therefore, the methods and techniques disclosed herein can be used to provide a successful voxel-by-voxel deposition of material to form continuous tracks and layers of material in voxel-by-voxel material deposition-based additive manufacturing using local high-frequency, small-displacement oscillatory strain-energy.

In an exemplary embodiment an acoustic-energy deposition system to deposit material from a feedstock material is disclosed. The system includes at least one Directed Acoustic Energy Deposition (DAED) tool configured to apply acoustic energy to soften the feedstock material, the applied acoustic energy selected from at least one of three vibrational modes, the DAED configured to apply intermittent material-tool contact to allow continuous deposition; and a drive system to move the DAED tool in at least one of three-coordinate positions.

In an exemplary embodiment an acoustic-energy deposition system to deposit material from a feedstock material is disclosed. The system includes a print head that is movable in one or more dimension and to feed a solid-metal wire to form subsequently each layer of a three-dimensional structure, the metal voxel being formed from the solid-metal wire, the print head being configured to apply intermittent material-tool contact to form at least one form of deposition selected from continuous depositions and step-and-print deposition.

In an exemplary embodiment an acoustic-energy deposition system to deposit material from a feedstock material is disclosed. The system includes an acoustic-energy coupling tool to deform, substantially athermally, the feedstock material based on a selected vibrational mode of the acoustic-energy coupling tool while the acoustic-energy coupling tool is at least partially in contact with the feedstock material, the DAED tool being configured to apply intermittent material-tool contact to form at least one form of deposition type selected from continuous depositions and step-and-print depositions; and a transducer configured to produce the ultrasonic acoustic-energy to be applied to the acoustic-energy coupling tool.

In an exemplary embodiment at least one Directed Acoustic Energy Deposition (DAED) tool configured to deform and deposit a feedstock material is disclosed. Each of the at least one DAED tool is includes an acoustic-energy coupling tool to deform, substantially athermally, the feedstock material based on a selected vibrational mode of the acoustic-energy coupling tool while the acoustic-energy coupling tool is at least partially in contact with the feedstock material; a transducer configured to produce an ultrasonic acoustic-energy signal to be applied to the acoustic-energy coupling tool; a coupling horn disposed between the transducer and the acoustic-energy coupling tool to couple and amplify the ultrasonic acoustic-energy signal produced by the transducer; and a feed-forward control to apply one or more changes to the at least one DAED tool, the one or more changes selected from changes in at least one of energy density, an amplitude of the ultrasonic acoustic-energy signal, and a frequency of the applied acoustic signal to effect a plastic change in the feedstock material, the DAED tool being configured to apply intermittent material-tool contact to form at least one form of deposition type selected from continuous depositions and step-and-print depositions.

In an exemplary embodiment, a method for deforming and depositing a feedstock material is disclosed. The method includes selecting the feedstock material; inserting the feedstock material into a Directed Acoustic Energy Deposition (DAED) tool; selecting at least one parameter to control the DAED tool from parameters including selecting an energy density; selecting an amplitude of vibration, selecting a vibrational mode, and selecting a velocity of the DAED tool; introducing intermittent material-tool contact to apply intermittent material-tool contact to form at least one form of deposition type selected from continuous depositions and step-and-print depositions; and deforming and depositing the feedstock material.

### BRIEF DESCRIPTION OF THE FIGURES

FIG. 1 shows a simplified example of a Directed Acoustic Energy Deposition (DAED) tool, along with a material feedstock and a surface plate, upon which material depositions are added;

FIG. 2 shows examples of various vibrational modes of the exemplary DAED tool of FIG. 1;

FIG. 3A is a schematic view of an exemplary intermittent material-tool contact pattern that may be used to produce continuous voxel-by-voxel deposition, in accordance with the disclosure provided herein;

FIG. 3B is a schematic view of another exemplary intermittent material-tool contact pattern that may be used to produce continuous voxel-by-voxel deposition, in accordance with the disclosure provided herein;

FIG. 3C is a schematic view of another exemplary intermittent material-tool contact pattern that may be used to produce continuous voxel-by-voxel deposition, in accordance with the disclosure provided herein;

FIG. 3D is a schematic view of another exemplary intermittent material-tool contact pattern that may be used to produce continuous voxel-by-voxel deposition, in accordance with the disclosure provided herein;

FIG. 4A is a top-view example of metal tracks produced by a square-wave path of a deposition tool used in an additive-manufacturing system, using intermittent wire-tool interaction techniques, in accordance with various embodiments described herein;

FIG. 4B is a top-view example of metal tracks produced by an inverted saw-tooth path of a deposition tool used in an additive-manufacturing system, using intermittent wire-tool interaction techniques, in accordance with various embodiments described herein;

FIG. 5A shows an example of a hardware stack for application of acoustic energy, in accordance with various embodiments;

FIG. 5B shows a cross-sectional example of the end-effector of FIG. 5A, in accordance with various embodiments;

FIGS. 6A and 6B show examples of tool-tip geometries for voxel material-deposition to reduce or eliminate interactions between the tool and neighboring voxels of material;

FIG. 7 shows an example of an additive-manufacturing system in accordance with various embodiments disclosed herein; and

FIG. 8 shows an exemplary embodiment of a method of for deforming and depositing a feedstock material.

### DETAILED DESCRIPTION

The disclosed subject matter will now be described in detail with reference to a few general and specific embodiments as illustrated in various ones of the accompanying drawings. In the following description, numerous specific details are set forth in order to provide a thorough understanding of the disclosed subject matter. It will be apparent, however, to one skilled in the art, that the disclosed subject matter may be practiced without some or all of these specific details. In other instances, well-known process steps or structures have not been described in detail so as not to obscure the disclosed subject matter. Further, although various examples are supplied and described herein, much of the material described may be considered as examples to provide a context so that a person of ordinary skill in the art may appreciate the disclosed subject matter.

For example, although many times the acoustic-energy deposition processes disclosed herein use various types of metals as examples, the disclosed subject matter is not limited to metals only and may be readily applied with other materials or combinations of materials as described herein. Further, various embodiments of tool paths are shown as examples only. Upon reading and understanding the disclosed subject matter, a person of ordinary skill in the art will recognize that one or more of these tool paths may be combined or other types of tool paths, not shown explicitly, may be used as well. All such tool paths are considered as being within a scope of the disclosed subject matter.

Further, as disclosed herein, various effective methods and techniques (such as an intermittent material-tool contact) isolate and either reduce or eliminate linear strain in the voxel along a direction of tool travel during a voxel-deposition step. Therefore, the methods and techniques disclosed herein can be used to provide a successful voxel-by-voxel deposition of material to form continuous tracks and layers of material in voxel-by-voxel material deposition-based additive manufacturing using local high-frequency, small-displacement oscillatory strain-energy.

### General Considerations for Deposition of Solid-Metal Voxels

The property and performance of metal and other material components and parts may be linked to their various chemistries and microstructures. For example, in the field of manufacturing, one of the most sought-after metal-processing technologies is the ability to control microstructures of a metal part or component at the same time the part is being made. The desire for controlling the microstructures holds true in both subtractive processes and additive processes.

As is known to a person of ordinary skill in the art, subtractive processes include lathe turning, routing, planning, milling, and other shaping processes, as well as forming process such as forging, extruding, drawing, and other plastic deformation processes. Additive processes include various 3D printing schemes known in the art including as Selective Laser Melting. Depending of the physical principles of the metal process technology, this is very difficult to achieve, since control of microstructure and control of physical dimension and other attributes are often times at odds when it comes to process parameters sets that would allow them to happen.

Various innovations in the research described in this disclosure represents a revolutionary way of not only producing high-quality metal components at room temperatures, but also the ability to control and tune the microstructure, and therefore the property and performance of the product, in-process at the same time the part is being built. This innovation involves the use of high frequency (e.g., in one embodiment, the frequency range may from about 5 kHz to about 60 kHz; in another embodiment, the frequency range may be from about 60 kHz to about 180 kHz), small-amplitude (e.g., about 0.5 micrometers to about 2 micrometers) shear deformations induced locally at the voxel of material as it is being deposited to form the tracks, layers, and bulk of a three-dimensional (3D) printed component or part. Each of the selected frequencies and amplitudes can be produced at a given power level. The component or part can be printed from metals, polymers, or a combination of the two materials. As a result of this application of ultra-fast shear deformation locally, the microstructures of the voxel can be controlled in real-time by controlling how the defects in the crystalline lattice interacts. Due to the high frequency and small amplitude nature of this process, the introduced changes in the microstructure only occur locally. When combined with a metal 3D printing process, it, therefore, can be designed to control only portions of a metal part or the entire part.

As is understandable to a person of ordinary skill in the art, plasticity describes the deformation of a (solid) material undergoing non-reversible changes of shape in response to applied forces. That is, the deformation of the material has exceeded the elastic range, in which removal of the applied stress to an object allows the material to return substantially to the object's original shape.

Performance of a part is largely determined by its properties, be it physical, mechanical, electrical, chemical, etc. Among which, the mechanical property of a metallic part largely determines the mechanical performance of the said part. Mechanical property in crystalline metals are dictated by the chemical bonding, crystalline structure, and “defects” in the crystalline structure of the metal, namely dislocations, vacancy clusters, grain boundaries, precipitates, and phases, etc. in the context of the proposed technology, the grain boundaries (number of gains and their geometry), and phases can be controlled by using high-frequency vibrations. Based on observations in our existing work, by adding different amounts of acoustic energy (in the form of high-frequency vibrations) into a metal the grain evolution process can be controlled such that the average size of grains and the shape of grains can be tuned to a desired range. In the terms of grain size, normally the smaller the grains are, overall the strength of the material increases. This means that by controlling the size of the grains in the metal, the strength of a part can be controlled and tuned to desired values. In the proposed technology, by increasing the amounts of acoustic energy imposed on the metal during a steady forming process, the size of the grains in the material can be increased by lower the acoustic energy, and vise-versa. It is also observed that by coupling of acoustic energy during metal shaping, the shape of the grains has a desired isotropic geometry (e.g., closer to a sphere). This means the overall property of the material is isotropic, or the same in whichever direction its property is evaluated. This is a desired characteristic for more engineering mechanical parts.

In one exemplary embodiment, the acoustic-energy process described herein is implemented by using a piezo-ceramic crystal-based actuator working in its mechanical resonance such that the material voxel is directly in contact with the tip of the tool. The tip of the tool is used to guide the voxel and continuously deposit metal voxels to form tracks, layers, and bulk of a metal 3D part, while the amplitude of the shear deformation locally is controlled to achieve controlled local microstructure.

In various examples and embodiments described herein, the disclosed subject matter includes:
A machine that can produce additively manufactured metal components in ambient conditions with desired microstructure, and therefore performance, without any post-fabrication processing;
A stand-alone tool that can be introduced into an existing metal 3D-printing technology to introduce bulk to voxel level microstructure, and therefore performance, tuning of metal components;
A stand-alone technology that can be used to perform the described technology on an existing metal component to change its surface properties to allow better performance (e.g., structural, electrical, or chemical); and
A technology and tool that can be used to tune the property, and therefore the performance, of the metal component in an assembly of parts/components of various materials that are otherwise impossible because of the temperature incompatibility between the different materials in the assembly.

In general, and as is known in contemporaneous arts, metals can be heat treated to alter the properties of strength, ductility, toughness, hardness, or resistance to corrosion. Common heat treatment processes include annealing, precipitation hardening, quenching, and tempering. The annealing process softens the metal by allowing recovery of cold work and grain growth. Quenching can be used to harden alloy steels, or in precipitation hardenable alloys, to trap dissolved solute atoms in solution. Tempering will cause the dissolved alloying elements to precipitate, or in the case of quenched steels, improve impact strength and ductile properties.

However, the technology described herein is superior to other heat-based approaches for several reasons. These reasons include, but are not necessarily limited to, (1) the technology described herein does not use heat to induce microstructure changes to metal, but precisely applied mechanical energy which is 1,000 to 1,000,000 times more energetically efficient for metal shaping and microstructure control; (2) the technology described herein uses and generates no heat so the entire process stays at room temperature, and therefore eliminates the danger and risk of fire or explosion when working with metals such as elemental aluminum (Al) and titanium (Ti), or various alloys thereof, in the context of additive manufacturing; and (3) the technology described herein does not raise the temperature of the metal being processed, which eliminates oxidation of the process metal that heat-based processes are prone to, it therefore eliminates the need for shielding gases or vacuum required for some metals.

It is now well established that simultaneous application of acoustic energy during deformation results in lowering of stresses required for plastic deformation. This phenomenon of acoustic softening has been used in several manufacturing processes, but there is no consensus on the exact physics governing the phenomenon. To further the understanding of the process physics, as described herein, after-deformation microstructure of aluminum (Al) samples deformed with simultaneous application of kilohertz range acoustic energy was studied using Electron-Back-scatter Diffraction (EBSD) analysis. The microstructure shows evidence of acoustic energy enabled dynamic recovery. It is found that the sub-grain sizes increase with an increase in acoustic energy density applied during deformation. A modified Kocks-Mecking (KM) model, described in more detail below, for crystal plasticity has been used to account for the observed acoustic energy enabled dynamic recovery. However, these standard models provide no information on microstructure evolution during the deformation process with simultaneous application of acoustic energy. Therefore, the standard KM model was modified to more closely represent the physical processes occurring with the disclosed subject matter.

Using the modified KM model, predicted stress versus strain curves were plotted and compared with experimental results. Good agreements were found between predictions and experimental results. The detailed description herein identifies an analogy between microstructure evolution in hot deformation and that in acoustic energy assisted deformation.

The study of microstructure evolution is imperative in that it can provide insights into the acoustic softening phenomenon and enables the development of a constitutive model that accurately captures the stress evolution during a static deformation process with simultaneous acoustic energy irradiation.

The inventors have shown characterization of microstructure using Electron Backscatter Diffraction (EBSD) analysis of aluminum samples after compression has been carried out. The microstructure characterization shows evidence of athermal dynamic recovery similar to that observed during hot deformation. As noted above, a model based on the one-internal-variable crystal plasticity model, the Kocks-Mecking model, has been used to predict the effect of simultaneous acoustic energy irradiation on stress evolution during compression.

Acoustic softening has been used to improve several manufacturing processes by taking advantage of the associated reduction in stresses required to achieve and sustain plastic deformation. Though the applications of acoustic softening to several manufacturing processes is wide-spread, understanding of the effects of acoustic softening on metals has not previously reached maturity. It is, therefore, important, particularly in the context of their microstructure which affects the eventual material properties to gain deeper understanding of the governing physics, which can result in further innovations in manufacturing. That understanding has been considered and is presented herein.

### The Kocks-Mecking Model for Crystal Plasticity for Thermal-Energy-Induced Stress Reduction

During hot deformation, as material is strained, new dislocations are generated. The increase in entanglement of dislocations in the material results in a rise in the stress required, for aluminum further deforming the material. The increase in stress required for further deforming the material is referred to as strain hardening.

For deformation at relatively low temperatures and high strain rates, generation of dislocations is faster due to which the steady state is reached at higher overall dislocation densities, and therefore smaller sub-grain sizes.

The Kocks-Mecking (KM) model embodies this phenomenon of dislocation density evolution by using a single internal variable dependent on dislocation density, relating the plastic strain rate, \dot{γ}^{p}, to the shear stress, τ, through the kinetic equation given by equation (1):

$${\dot{γ}}^{p} = {\dot{γ}}_{0} exp ( \frac{- Δ G}{k T} ) \qquad ( 1 )$$

where \dot{γ}₀ is the pre-exponential factor and ΔG is the Gibbs free energy. As is known in the art, Gibbs free energy is a function of obstacle distribution and is related to total free energy, ΔF, as shown in equation (2):

$$Δ G = Δ {F ( 1 - {( \frac{τ}{\hat{τ}} )}^{p} )}^{q} \qquad ( 2 )$$

where p and q are ¾ and 4/3, respectively for aluminum. In general, however, the values for p and q are fitting parameters that relate to slip systems in crystalline metals. In this example, they are related to aluminum having a Face-Centered-Cubic (FCC) crystalline structure. The value of ΔF=0.5 μb³, where u is the shear modulus of the material and b is the burgers vector.

The KM model is based on a single internal variable, \hat{τ}, known as a mechanical threshold. The mechanical threshold depends on a dislocation density, ρ. The mechanical threshold is a demarcation between thermally activated flow and viscous glide; below the mechanical threshold, plastic flow is only due to thermal activation and above the threshold is due to rate sensitive viscous glide. The relationship between \hat{τ} and ρ is given by equation (3):

$$\hat{τ} = αμ b \sqrt{ρ} \qquad ( 3 )$$

where α is a numeric constant. These variables are semi-empirical constituent relations, so they may be determined experimentally. Further, such variables are well-documented in the literature.

The evolution of dislocation density with plastic strain is controlled by two terms. The first term is the dislocation storage term that causes athermal hardening. The first term is inversely proportional to the average spacing between dislocations, and is therefore, directly proportional to \sqrt{ρ}. The second term is the dislocation annihilation term, which accounts for dynamic recovery due to the cross-slip of screw dislocations and climb of edge dislocations. The second term is proportional to ρ. The terms are used in a change in dislocation density to a change in resolved shear strain in the slip plane according to equation (4):

$$\frac{d ρ}{d {γ}^{p}} = \frac{d {ρ}^{+}}{d {γ}^{p}} + \frac{d {ρ}^{-}}{d {γ}^{p}} = {k}_{1} \sqrt{ρ} - {k}_{2} ρ \qquad ( 4 )$$

where γ^{p} is the resolved shear strain in the slip plane. The coefficient for the dynamic recovery term, k₂, is given by equation (5):

$${k}_{2} = {{k}_{20} ( \frac{{\dot{γ}}^{p}}{{\dot{γ}}_{0}^{*}} )}^{- 1 / n} \qquad ( 5 )$$

where k₂₀ is a numeric constant. These constants, discussed in more detail below, are crystalline-structure dependent. Consequently, these values differ for materials with different crystalline structures and lattice constants. The term k₂ is the strain rate and is temperature dependent. For low temperatures, n is inversely proportional to temperature, T, and \dot{γ}*₀ is constant. However, this is a constitutive relation that links the dislocation density evolution with how an applied force is resolved to acting on dislocations on their slip planes based on the lattice structure and geometry. The value is experimentally obtained. At low temperatures, the cross slip and climb mechanisms are not activated, so the relation is governed by geometry of lattice. The value of \dot{γ}*₀ is therefore geometrically determined once the lattice geometry is known. The demarcation between low temperatures and high temperatures is typically defined as ⅔ of the melting temperature for a given material.

However, at higher temperatures, \dot{γ}*₀ is given by the Arrhenius equation (6):

$${\dot{γ}}_{0}^{*} = {\dot{γ}}_{00}^{*} exp ( \frac{- {Q}_{d}}{k T} ) \qquad ( 6 )$$

where Q_{d} is activation energy for self-diffusion or dislocation climb, k is the Boltzmann constant, and Tis temperature. For high temperatures, n is constant between 3 and 5. In hot working temperatures, dislocation climb and cross slips are activated, so the dislocation kinetics and dynamics play increasingly more important roles as temperature increases. These values are typically experimentally obtained by fitting curves.

To relate shear stresses and strains in a single-crystal material to macroscopic axial stresses and strains in polycrystalline materials, Taylor's factor, M, given by equation (7) is used:

$$M = \frac{σ}{τ} = \frac{{γ}^{p}}{{ε}^{p}} \qquad ( 7 )$$

where M is microstructure dependent. The Taylor's factor, M, is an empirical scaling factor used to translate the plasticity models derived for single-crystal lattice into the more realistic poly-crystalline structures. (For most metal products, the crystalline structure in the product is not exactly the same throughout. There are grains where within each grain the crystalline structure is the same as others, but from one grain to another the orientation varies.) The value is captured by comparing the principle stresses, σ, with the shear stresses, τ. Since M is assumed to be changing much more slowly than the evolution of dislocation density, M is assumed to be constant.

### Modification to KM Model to Account for Acoustic Softening

The after-deformation microstructure of the aluminum samples deformed under the influence of acoustic energy shows evidence of strain rate and athermal acoustic energy dependent dynamic recovery analogous to those observed in hot deformation. Details about the microstructure characterization results are given in more detail, below. To account for acoustic-energy-induced dynamic recovery, equations (4) and (6), as used to determine \dot{γ}*₀ described above for the KM model, are modified according to equation (8):

$${\dot{γ}}_{0}^{*} = {\dot{γ}}_{00}^{*} exp ( \frac{- {Q}_{d} χ}{k T E} ) \qquad ( 8 )$$

where x is a constant with units of J/m³. The value of x is one of the keys to the modification as detailed herein. The value of x is introduced to modify the thermal activation energy term Q_{d}. Effectively, since we are now no longer using random atom vibrations (thermal vibrations) to overcome the energy barriers for dislocation motion, but instead a “structured” lattice vibration (acoustic energy), the activation should see a scaling effect. It also partially cancels out the additional units introduced by “E.” E is energy density in Joules per cubic meter [J/m³] and is determined from equation (9):

$$E = {α}^{2} {ω}^{2} {ρ}_{m} \qquad ( 9 )$$

where α is the amplitude of vibration, w is the frequency in rad/sec, and μₘ is the density of the material undergoing acoustic softening.

Based at least partially on the changes to the KM model to incorporate changes based on effects of acoustic softening, the effect of acoustic energy here can be considered the minimum amount of acoustic energy density required to achieve acoustic softening. An increase in the amount of acoustic energy density used during deformation results in an increase in the value of \dot{γ}*₀ in equation (6), thereby causing an increase in k₂ in equation (5). As k₂ changes, the dislocation density, and therefore the microstructure, evolution changes accordingly, as modeled by equation (4).

Therefore, as discussed in more detail below, applying changes in at least one of energy density, amplitude of an applied acoustic signal, or frequency of the signal to effect a plastic change in material experiencing acoustic softening, allows advance control in at least two ways. First, a look-up table developed for each material to be deposited lists pre-determined grain structures for each of the three variables (i.e., energy density, amplitude, and frequency plus velocity of the material-depositing system) allows selected parameters for a desired grain microstructure to be transferred to a feed-forward control system. Second, a real-time control system incorporates in-situ metrology to measure, in substantially real time, the microstructure of various deposited materials. The various parameters (e.g., the three variables and the system velocity) may then be changed in a feedback control system to achieve a desired microstructure of the material being deposited. Each of these concepts is discussed in greater detail below.

### Applications of Described Processes in Metal Surface Repair

During service or during manufacturing, cracks often form on the surface of metal components, often due to cyclic loading. These cracks grow to cause faster failure of components. Currently, fusion welding processes like Tungsten Inert Gas (TIG) are used to fill these cracks and thereby repair the surface of the components. These processes use heat energy, usually generated by an electric arc, to melt filler material and fill the crack. More recently, processes such as Laser Engineered Net Shaping (LENS), Laser Direct Metal Deposition (LMD), and Cold Spray have also been used for repairing cracks. The main disadvantage of these processes is that they create a large heat affected zone (HAZ) around the repaired crack because of the large amount of heat energy used to melt the filler material. This significantly alters the microstructure of component in the HAZ.

The technique described in this disclosure eliminates the aforementioned issues in the final product associated with thermal history and solidification. It is a solid state, room temperature technique in which high-frequency small amplitude local shear strain are used to achieve energy-efficient volumetric conformation of filler filament into a surface defect. Once the surface defect is filled, this technique also induces metallurgical bonding on filler-repair surface interfaces. This two-fold effect is similar to what heating and melting a filler metal does, but in this new technique no heat is used and both the filler and repaired surface remains solid at room temperatures the entire time. Further, the use of high-frequency small amplitude oscillatory shear strain results in softening of the metal filler and allows it to “flow” and conform to the shape of the surface defects. Additionally, it also enables large amount of materials exchange at the interface to enable metallurgical bonding. Since the technique described here use no heat energy and causes a negligible temperature-rise during the process, microstructure of the component around the repaired region remains unaffected. This process can be used to repair metal components in various industries ranging from aerospace, maritime and other automotive industries to small-scale fabrication shops.

As is well-known a person of ordinary skill in the art, elastic deformation is reversible. Once the forces are no longer applied, the object returns to its original shape. Plastic deformation is irreversible. However, an object in the plastic deformation range will first have undergone elastic deformation, which is reversible, so the object will return part way to its original shape. Under tensile stress, plastic deformation is characterized by a strain hardening region and a necking region and finally, fracture (also called rupture). During strain hardening the material becomes stronger through the movement of atomic dislocations. The necking phase is indicated by a reduction in cross-sectional area of the specimen. Necking begins after the ultimate strength is reached. During necking, the material can no longer withstand the maximum stress and the strain in the specimen rapidly increases. Plastic deformation ends with the fracture of the material.

Another deformation mechanism is metal fatigue, which occurs primarily in ductile metals. It was originally thought that a material deformed only within the elastic range returned completely to its original state once the forces were removed. However, faults are introduced at the molecular level with each deformation. After many deformations, cracks will begin to appear, followed soon after by a fracture, with no apparent plastic deformation in between. Depending on the material, shape, and how close to the elastic limit it is deformed, failure may require thousands, millions, billions, or trillions of deformations.

There are two ways to determine when a part is in danger of metal fatigue; either predict when failure will occur due to the material/force/shape/iteration combination, and replace the vulnerable materials before this occurs, or perform inspections to detect the microscopic cracks and perform replacement once they occur. There are two ways to determine when a part is in danger of metal fatigue; either predict when failure will occur due to the material/force/shape/iteration combination, and replace the vulnerable materials before this occurs, or perform inspections to detect the microscopic cracks and perform replacement or repair once they occur.

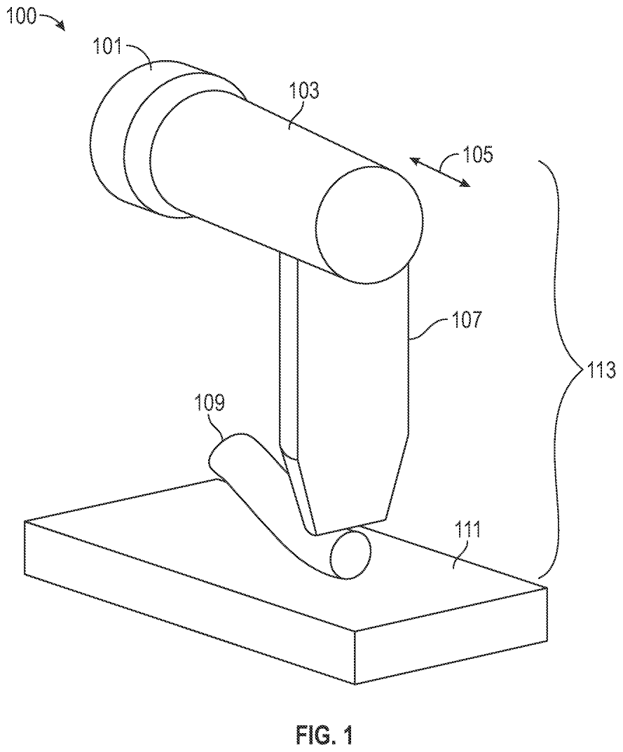

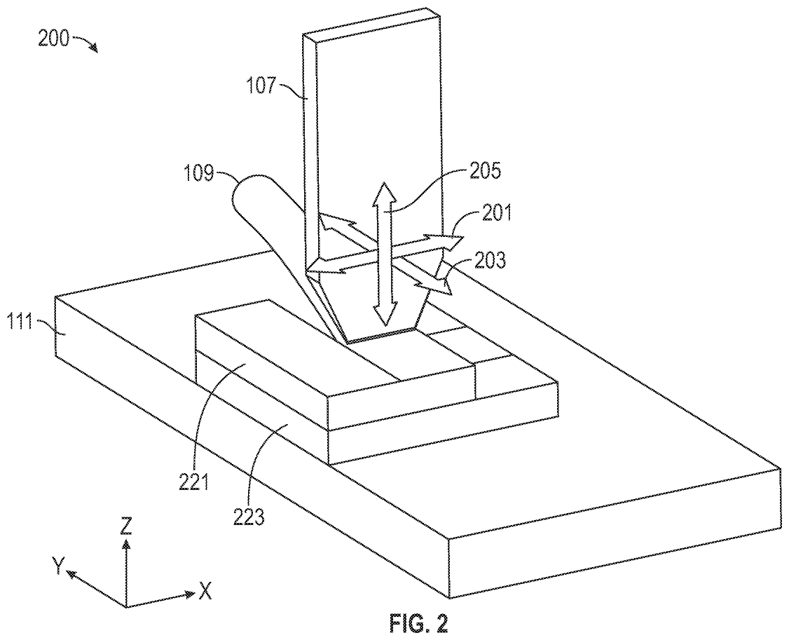

With reference now to FIG. 1, a simplified example 100 of a Directed Acoustic-Energy Deposition (DAED) tool 113, along with a material feedstock 109 and a surface plate 111. In one embodiment, the surface plate 111 may comprise a test plate for measuring, for example, uniaxial compression loading from the DAED tool 113 upon the material feedstock 109. In another embodiment, the surface plate 111 may comprise various types of substrate upon which material depositions are formed, deposited, or added, as shown and described with reference to FIG. 2, below.

The DAED tool 113 is shown to include a transducer 101, a coupling horn 103, and an acoustic-energy coupling tool 107. In various embodiments, the acoustic energy may comprise ultrasonic energy. Although one mode of oscillation, a shear transverse mode 105, is indicated in FIG. 1, other vibrational modes are discussed in more detail, below, with respect to FIG. 2.

The coupling horn 103 couples and amplifies the acoustic energy (e.g., ultrasonic energy) from the transducer 101 to the acoustic-energy coupling tool 107. In various embodiments, the coupling horn 103 is comprised of stainless steel and the acoustic-energy coupling tool 107 is comprised on tungsten carbide. Since the acoustic-energy coupling tool 107 is used to deform the material feedstock 109, tungsten carbide or another material with a relatively high density and hardness may be selected to form the acoustic-energy coupling tool 107. However, the skilled artisan will recognize that the coupling horn 103 and the acoustic-energy coupling tool 107 may be comprised of a variety of materials.

The transducer 101 converts an alternating current (AC) signal into an acoustical signal (e.g., a sound wave). In various embodiments, as discussed in more detail, below, the transducer may operate in a frequency range of between about 5 kHz to about 350 kHz. However, upon reading and understanding the disclosure provided herein, the skilled artisan will recognize that a variety of other frequencies may be employed, both below 5 kHz and above 350 kHz. A selection of frequency is at least partially dependent on a material used as the material feedstock 109. In one embodiment, the transducer 101 is a piezoelectric transducer. In another embodiment, the transducer 101 is an ultrasonic transducer. In still another embodiment, the transducer 101 is a capacitive transducer. Each of these transducer types is known in the art by a person of ordinary skill in the art.

In various embodiments, the material feedstock 109 may comprise a solid-metal filament that is used as a starting material to form a three-dimensional object via metallurgical bonding between, for example, the material feedstock 109 and the surface plate 111. In various embodiments, the material feedstock 109 may comprise a solid-polymeric filament that is used as the starting material to form the 3D objects. Also, the material feedstock 109 is described herein as having a circular cross-sectional area. However, the material feedstock 109 may have any cross-sectional area including oval, square, rectangular, and a variety of other shapes.

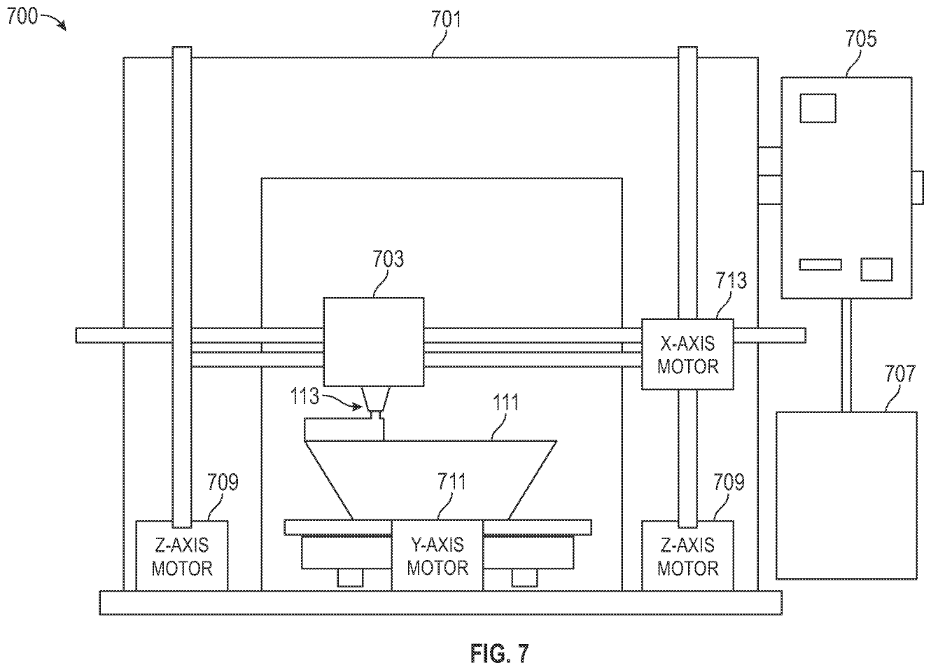

Through the acoustic energy applied (e.g., ultrasonic energy) to the material feedstock 109, the DAED tool 113 softens the material beyond the elastic region of the material and plasticly deforms the material, thereby extruding the material feedstock 109 to directly “write” the tracks and layers that comprise the 3D component or components. Therefore, in an example where the material feedstock 109 comprises a metal (e.g., Al), the solid-metal filament of the material feedstock 109 is guided, shaped, and metallurgically bonded to a substrate (e.g., the surface plate 111 or the previous track or layer) as well as the adjacent filaments 3D-volume element-by-3D volume-element (i.e., voxel-by-voxel) using a guided version of the DAED tool 113 on a positioning system. An exemplary positioning system is shown and described in detail with reference to FIG. 7, below.

In the foregoing examples, the DAED tool 113 was shown to operate in the shear transverse mode 105 (see FIG. 1) for ease of understanding. However, the DAED tool 113 can be structured to operate in one or more vibrational modes.

Referring now to FIG. 2, examples of various vibrational modes 200 of the DAED tool 113 of FIG. 1 are shown. One or more of the vibrational modes may be used to form tracks of material in an exemplary additive-manufacturing operation. FIG. 2 shows a first track of material 223 deposited, or otherwise formed, on the surface plate 111. A second track of material 221 is then formed over and substantially orthogonal to the first track of material 231. As shown in FIG. 2, multiple tracks are, for example, deposited side-by-side in a first layer and then tracks are formed side-by-side in a second layer that is substantially orthogonal to the tracks of the first layer.

In various embodiments, there are primarily three different modes of tool vibration that are selectable with respect to a deposited or formed part. As shown in FIG. 2, the three vibrational modes include a first shear (transverse) mode 201, a second shear (transverse) mode 203, and a longitudinal mode 205. At least one of three vibrational modes can be used to couple acoustic energy (e.g., ultrasonic energy) into the material feedstock 109 to perform operations of material forming (e.g., material deposition) and material bonding (material feedstock to a substrate or material feedstock to one or more prior-deposited layers of material feedstock).

Where the material feedstock 109 is a metal, the first shear (transverse) mode 201 and the second shear (transverse) mode 203 are more efficient than the longitudinal mode 205 in forming and bonding of metal voxels to build components or parts. Therefore, the longitudinal mode 205 may be less suitable for forming and bonding of metal voxels than the vibrational modes of the first shear (transverse) mode 201 and the second shear (transverse) mode 203.

Different modes of vibration may be used for different materials (e.g., metals versus polymers) or different crystalline structures (e.g., fully crystalline versus semi-crystalline versus fully amorphous). The exact mechanisms for these differences are still under investigation. However, to transition from the elastic region to the plastic region, vibrational amplitude and mode of vibration may be more strongly-determining factors than frequency. Current observations indicate that, in either of the shear modes of vibration, the material feedstock 109 experiences greater shear stresses as opposed to the longitudinal mode of vibration. When in the plastic deformation region, these shear stresses cause the resolved shear stress to be overcome more effectively, and therefore activate dislocation motion and lattice defect gradients in the material to allow for athermal diffusion of the material.

Following the same line of thought, when the vibration amplitude of a shear mode vibration increases, the increased amplitude allows the material in the feedstock to experience larger amounts of shear plastic deformation in each cycle of vibration. Consequently, more vibrational energy is coupled into the dislocation motion and forming defect gradients needed for diffusion and material bonding on internal interfaces of the built component or part.

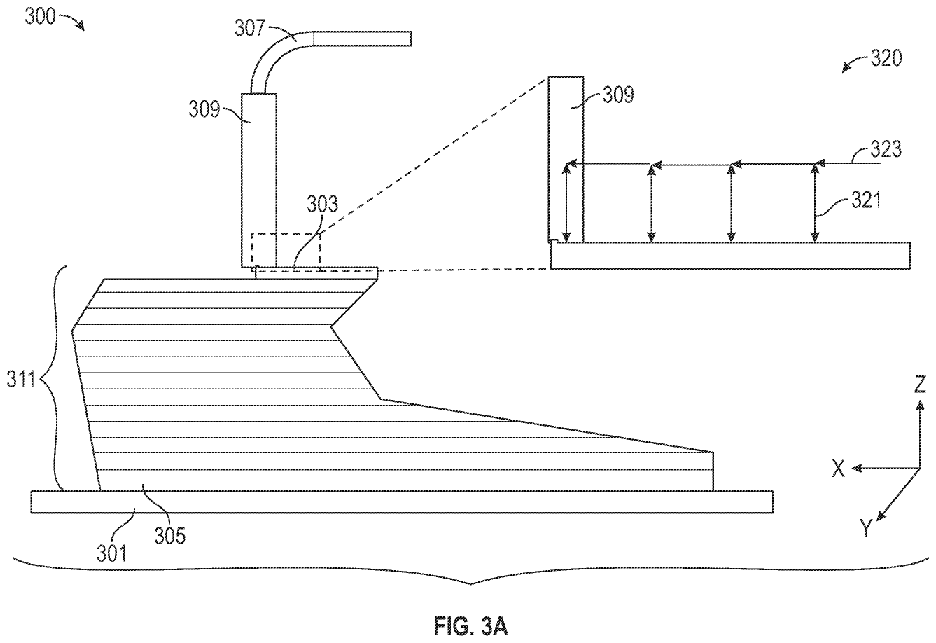

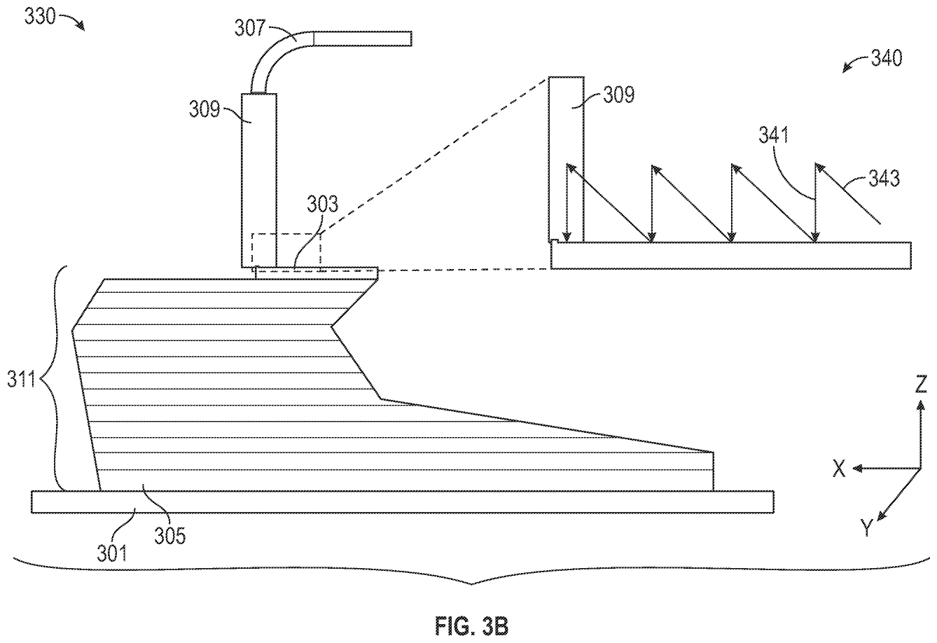

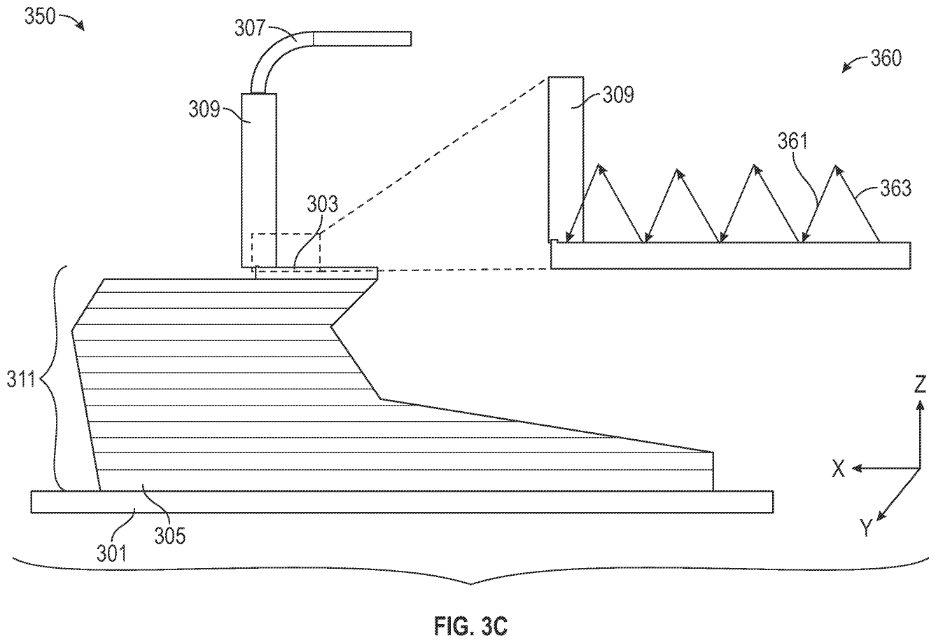

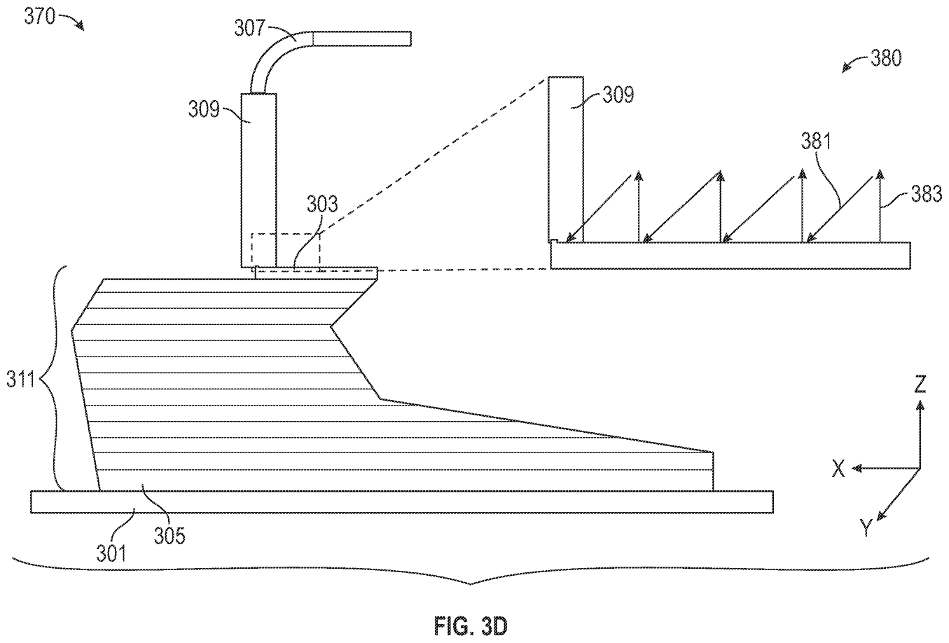

FIGS. 3A through 3D show various examples of intermittent material-tool contact pattern that may be used to produce continuous voxel-by-voxel depositions. For example, two modes of intermittent material-tool interaction can be used to produce continuous tracks of deposited metal voxels. The tool uses local high-frequency, small-amplitude, oscillatory strain in a sequence of compressions of a voxel by the tool and an application of oscillatory strain-energy by the oscillatory movements of the tool. In one mode, the voxel is compressed first before the application of oscillatory strain-energy. This first mode is referred to herein as a “Step-And-Print” mode. In the second mode, the oscillatory movement in the tool remains on while the tool moves through its path steps; this second mode of operation is referred to as a “Continuous” mode.

Referring now to FIG. 3A, an embodiment of a system 300 for using the Step-and-Print mode and the Continuous is shown. A platform 301 (e.g., a substrate) on which a structure 311 is produced by successively depositing individual tracks 303 and layers 305. The tracks 303 and the layers 305 are formed adjacent to and on top of each other to additively manufacture the structure 311. The tracks 303 are deposited voxel-by-voxel from a solid-metal wire 307, from a tool 309. The tool 309 may be similar to or the same as the DAED tool 113 of FIG. 1.

A tool-control program is prepared such that each voxel-deposition cycle 320 includes, for example, the following steps: (1) the tool 309 traverses laterally to a subsequent x-y direction 323; the tool 309 moves down in a z-direction 321 and compresses the voxel to a pre-determined amount of compression; (3) acoustic-energy irradiation begins, and then turns off for a pre-determine amount of time (e.g., the time can vary from milliseconds to tens of seconds depending on a to-be-deposited material and desired process characteristics); and (4) the tool lifts up in the z-direction 321. This voxel-deposition cycle 320 repeats as the tool 309 progresses in the path defined by the tool-control program (e.g., a slicer program) in which a 3D model is sliced into layers and tracks for metal deposition.

In the Continuous mode of metal deposition, the voxel-deposition cycle 320 does not include turning the acoustic-energy irradiation on and off. Instead, while the tool 309 moves through the same physical movements as those of the Step-and-Print mode described above, the acoustic energy is kept on the entire time and is only interrupted or stopped when desired by the user (or program design) for other purposes (e.g., such as tool cleaning, etc.).

In the Continuous mode, one advantage is that the voxel-compression process becomes displacement controlled (as opposed to the force control in the Step-and-Print mode). The use of displacement-controlled voxel deposition brings about a number of new process characteristics, a few of which are described herein.

In FIG. 3B, an embodiment of a system 330 for using the Step-and-Print and Continuous mode is shown. A platform 301 (e.g., a substrate) on which a structure 311 is produced by successively depositing individual tracks 303 and layers 305. The tracks 303 and the layers 305 are formed adjacent to and on top of each other to additively manufacture the structure 311. The tracks 303 are deposited voxel-by-voxel from a solid-metal wire 307, from a tool 309. The tool 309 may be similar to or the same as the DAED tool 113 of FIG. 1.

A tool-control program is prepared such that each voxel-deposition cycle 340 includes, for example, the following steps: (1) the tool 309 traverses generally up in a z-direction at an angle with respect to z, to a subsequent x-y direction 343; (2) the tool 309 moves vertically down in a z-direction 341 and compresses the voxel to a pre-determined amount of compression. This voxel-deposition cycle 340 repeats, in either a Step-and-Print or Continuous mode as described above, as the tool 309 progresses in the path defined by the tool-control program (e.g., a slicer program) in which a 3D model is sliced into layers and tracks for metal deposition.

In FIG. 3C, an embodiment of a system 350 for using the Step-and-Print and Continuous mode is shown. A platform 301 (e.g., a substrate) on which a structure 311 is produced by successively depositing individual tracks 303 and layers 305. The tracks 303 and the layers 305 are formed adjacent to and on top of each other to additively manufacture the structure 311. The tracks 303 are deposited voxel-by-voxel from a solid-metal wire 307, from a tool 309. The tool 309 may be similar to or the same as the DAED tool 113 of FIG. 1.

A tool-control program is prepared such that each voxel-deposition cycle 360 includes, for example, the following steps: (1) the tool 309 traverses generally up in a z-direction 361, at an angle with respect to z, to a subsequent x-y direction 363; (2) the tool 309 moves down at an angle, with respect with z, towards the x-y position of the next voxel and compresses the voxel and compresses the voxel to a pre-determined amount of compression. This voxel-deposition cycle 360 repeats, in either a Step-and-Print or Continuous mode as described above, as the tool 309 progresses in the path defined by the tool-control program (e.g., a slicer program) in which a 3D model is sliced into layers and tracks for metal deposition.

In FIG. 3D, an embodiment of a system 370 for using the Step-and-Print and Continuous mode is shown. A platform 301 (e.g., a substrate) on which a structure 311 is produced by successively depositing individual tracks 303 and layers 305. The tracks 303 and the layers 305 are formed adjacent to and on top of each other to additively manufacture the structure 311. The tracks 303 are deposited voxel-by-voxel from a solid-metal wire 307, from a tool 309. The tool 309 may be similar to or the same as the DAED tool 113 of FIG. 1.

A tool-control program is prepared such that each voxel-deposition cycle 360 includes, for example, the following steps: (1) the tool 309 traverses vertically up in a z-direction 383; (2) the tool 309 moves generally down at an angle, with respect to z, towards the x-y position of the next voxel and compresses the voxel to a pre-determined amount of compression. This voxel-deposition cycle 360 repeats, in either a Step-and-Print or Continuous mode as described above, as the tool 309 progresses in the path defined by the tool-control program (e.g., a slicer program) in which a 3D model is sliced into layers and tracks for metal deposition.

Each of the two modes of deposition described forms results in slightly different process speeds at the voxel level, which can lead to larger build-time differences (build speed) in larger builds. In addition to speed, the bond quality differs when different deposition paths are used. The filament diameter-compression-voxel geometry correlations can have a significant effect on voxel compression tolerance, which can not only determine part dimension tolerances, but also whether the voxel compression at each layer stays within a process window to allow a build to continue.

In the Continuous mode the voxel geometry and dimension are more confined and closely linked to the tooling motion, thereby meaning the dimension and geometry control may be improved. Further, converting from a square-wave path to any of the non-orthogonal paths can result in a change in process speed. Converting from a square-wave path to any of the non-orthogonal paths can also result in changes in the mechanics of voxel compression/deposition, and therefore can change the geometry and tolerances of the process.

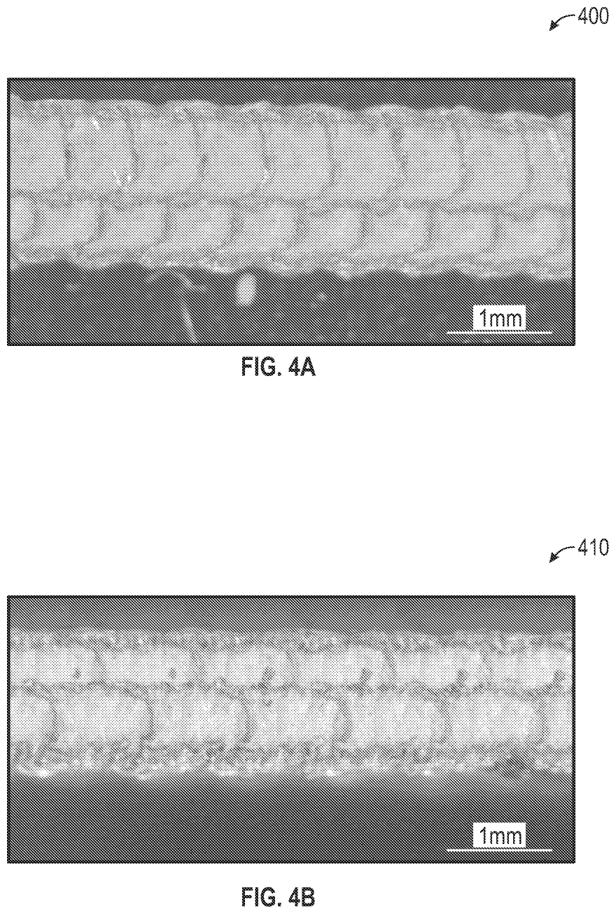

With reference now to FIG. 4A, a top-view 400 example of metal tracks produced by a square-wave path of a deposition tool used in an additive-manufacturing system, using intermittent wire-tool interaction techniques is shown. Voxels made using the square-wave path have substantially the same thickness as those made with non-orthogonal paths. However, the geometry of square-wave path voxels in the x-y (build plane) direction exhibit more isotropic shapes as compared with those made with non-orthogonal paths. The top-view 400 shows that the voxels deposited using the square-wave path are more square-like as opposed to the rectangular-shaped voxels resulted from a top-view 410 of an inverted saw-tooth path, as shown in FIG. 4B.

This difference in voxel geometry translates into a few key differences in characteristics of a formed or deposited part. First, a side surface “scalloping” effect in the track direction is smaller with a non-orthogonal path, whereas the square-wave path creates parts with a “wavy” surface feature in the track direction. Second, the width of the tracks made using the square-wave path is wider because of the geometry of the voxels in the build-plane direction. This difference is also evident in FIGS. 4A and 4B where the two-track walls formed using two different paths differs by about 15 to about 20%. This difference means that with a non-orthogonal path, the feature resolution of deposition is higher, and the minimal feature size is smaller.

The metal property remains more consistent through a voxel deposition step. Since acoustic-energy irradiation is substantially constant from initiation of tool-feedstock contact to the end of the compression/deposition cycle before the tool lifts from the deposited voxel, the amount of acoustic softening in the voxel remains substantially consistent (given that the power output from an acoustic-energy generator is in amplitude-tracking mode). This gives rise to more stable process, and better compression control, and therefore, dynamic recovery control in the voxel, thereby leading to better property control of a deposited material.

Consistent compression stress and strain rates throughout compression cycle can be beneficial to tool life as well. Since the tool sees the same resistance to its motion throughout the compression step, and the amount of acoustic softening remains substantially constant, the material strain rate remains substantially the same. The “microstructure evolution” history in the voxel as it is being compressed and deposited therefore remains substantially consistent. This consistency allows the load on the tool during deposition to see less variation, and therefore, a better tool life can be expected.

Further, the physical steps of turning on and off the acoustic-energy generator is eliminated in the Continuous; thereby resulting in decreased time in voxel-deposition cycles, and therefore increasing overall process speed.

In another aspect, the Continuous mode accelerates the build speed by about 10 times, and it increases the yield of the interface bond to over about 90% at each voxel, as compared with the Step-and-Print mode.

In the Continuous mode, the ultrasonic vibration in the tooling system is kept on which the tool rapidly steps through the print path without any pauses. In the Continuous mode, the inventors observed that as the acoustic energy input is kept on, increasing the voxel compression rate by a factor of from about 15 to about 20, from about 1 mm/s to about 20 mm/s, significantly increased the yield of voxel-to-voxel bonding, as well as track-to-track and layer-to-layer bonding.

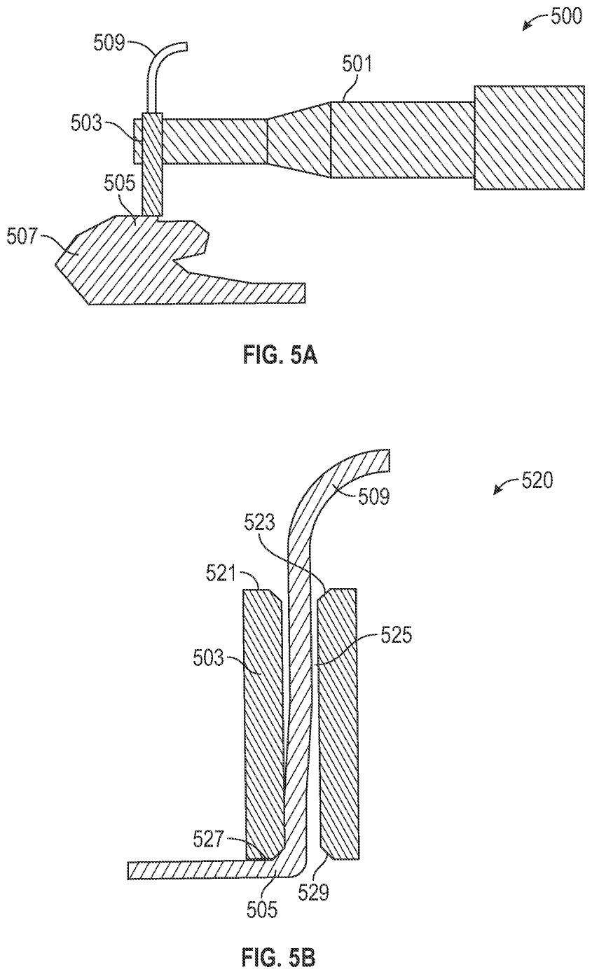

With reference now to FIG. 5A, an example 500 of an end-effector 503 of a hardware stack 501 for application of acoustic energy to a feedstock 509 (e.g., a solid-material wire-feedstock), is shown. Specifically, the drawings of FIGS. 5A and 5B show exemplary embodiments for directing the feedstock 509 through an opening (e.g., a through-hole) in a cylindrically shaped, acoustic-energy end-effector (e.g., the end-effector 503). The hole, as shown, is formed along the axial direction of the end-effector 503 in order to ensure coupling of acoustic energy into the feedstock 509 in the form of transverse, small-amplitude, high-frequency strains, as described herein. Upon reading and understanding the disclosed subject matter, a person of ordinary skill in the art will recognize that the shapes shown (e.g., a cylindrically shaped, acoustic-energy end-effector) are exemplary only so that the person of ordinary skill in the art may better understand the concepts of the disclosed subject matter. Consequently, such shapes are provided merely as examples.

FIG. 5B shows a cross-sectional example of the end-effector 503 of FIG. 5A. With concurrent reference to FIGS. 5A and 5B, the end-effector 503 of the hardware stack 501 can be on either end of the hardware stack 501. In a specific exemplary embodiment, the end-effector 503 can be a cylindrical rod with a center hole in the axial direction of the end-effector 503. The feedstock 509 is directed into the center hole on the top end 521 of the end-effector 503. The feedstock 509 exits the center hold on the opposing, bottom end 527 of the end-effector 503. A radius or fillet on the top-hole edges 523 and bottom-hole edges 529 hole edges, as well as a clearance 525 between the feedstock 509 and the center hole, can help to reduce, minimize, or eliminate scratching and scraping of the feedstock 509. The scratching and scraping can otherwise cause clogging of the end-effector 503, as well as other issues.

Once the feedstock 509 exits the end-effector 503, the feedstock 509 is directed to make a bend (e.g., a bend of approximately 90 degrees) such that the axial direction of the portion 505 of the feedstock 509 exiting the end-effector 503 passes the end-effector 503 is substantially orthogonal to the long axis of the end-effector 503. In the configuration shown in the example of FIG. 5A, acoustic energy from the hardware stack 501 is transferred, through the end-effector 503, into the portion 505 of the feedstock 509 directly between the bottom end 527 of the end-effector 503 and a build surface 507 (existing layer or build plate) in the form of high-frequency, low amplitude oscillatory shear strain. The portion 505 of the feedstock 509 directly between the bottom end 527 of the end-effector 503 and a build surface 507 creates a voxel. The shear strain enables material softening and interface fusing of the portion 505 of the feedstock 509 used for the voxelated construction of a three-dimensional component when the components described above are combined with a three-dimensional motion system, described herein, and a tool path following in which the end-effector 503 deposits material from the feedstock 509 voxel-by-voxel, track-by-track, and layer-by-layer.

As described above, the hardware stack 501 is arranged to direct the feedstock 509 through the end-effector 503 of the hardware stack 501 to route transverse-mode acoustic energy into the feedstock 509 for acoustic-energy-enhanced material softening and fusing. When used in conjunction with a three-dimensional positioning system and a pre-defined tool path, as described above, the hardware stack 501 can be used for three-dimensional printing, including additive manufacturing, of solid components. Although not shown explicitly, upon reading and understanding the disclosed subject matter, a person of ordinary skill in the art will recognize that small, z-direction movements of the hardware stack 501 and/or the end-effector 503 can be accomplished using, for example, linear variable-displacement transducers (LVDT), stepper motors, voice-coil motors and other types of linear actuators known in the relevant art. The small, z-direction movements can be used to assist in producing the tool paths as described with reference to FIGS. 3A through 3D, above.

The system described herein also provides an ability to introduce rotational alignment between bottom end 527 of the end-effector 503, the hardware stack 501, and the portion 505 of the feedstock 509 underneath the bottom end 527. The rotational alignment can help to ensure that the direction of oscillatory shear-strain is aligned with the axial direction of the portion 505 of the feedstock 509 used to create a voxel. The rotational alignment can thereby help energy and mode coupling between the system and the material to assist in softening and interface fusing in a voxel be deposited. As a non-linear tool path is used (see FIGS. 3A through 3d, along with the accompanying description, the end-effector 503 can move in any given direction on a build layer. When a motion direction change occurs, a rotation in the end-effector 503 about its axis helps ensure alignment between oscillatory shear-strain in a deposited or formed voxel and vibrational displacements of the end-effector 503. The center hole in the end-effector 503 reduces or minimizes the turning radius of the wire voxel as a turn occurs and allows for increases in print resolution.

The system described herein can also be used for other material systems in different matter states. For example, the material of the feedstock 509 can include polymers, metals, ceramics, composites, or biological tissues. The matter states can be crystalline solid, amorphous solid, liquid, and/or semi-liquid (or alloys in the “mushy” zone). Further, the system does not need to move in Cartesian coordinates as generally described above. The system can move in cylindrical, spherical, or other coordinate systems and/or with multi-axis motions.

Further, other forms of energy can be applied to the system to accomplish the same or similar results of softening and interface fusing. For example, optical energy (lasers, high-intensity infrared, etc.), chemical energy (reactions, secondary chemical injections, etc.) can be used.

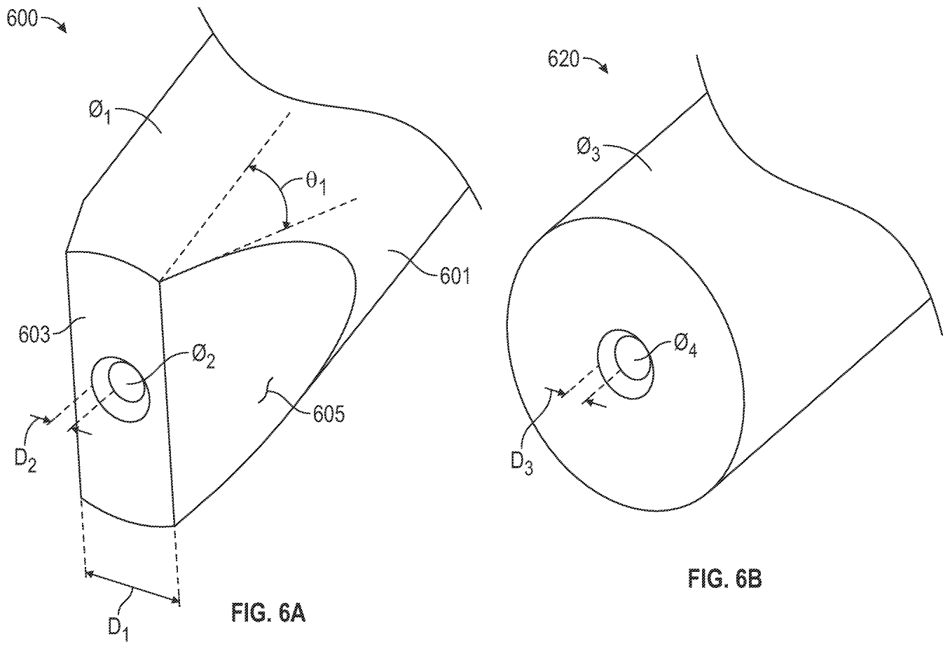

FIGS. 6A and 6B show examples of tool-tip geometries 600, 620 for voxel material-deposition to reduce or eliminate interactions between the tool and neighboring voxels of material. When using high-frequency, oscillatory strain-based material deposition and joining for building parts and/or components with, for example, non-single wall features, multiple tracks with, for example, 10% overlap can be used to fill up spaces in between outlines of a printed part or component.

In a specific exemplary embodiment, the tool-tip geometries 600, 620 may be formed or otherwise machined from tungsten carbide. When the tool-tip geometries 600, 620 are set up as shown in FIGS. 6A and 6B, contact between a tooling surface and the voxel generally only occurs when a particular voxel is being compressed and deposited, and does not occur when the neighboring track is being deposited, thereby causing over irradiation. Over irradiation of acoustic energy can result in undesirable material removal on the top surface of a part or component, as well as generating additional deformation and dislocations in neighboring tracks. These additional features can lead to premature failure of a part or component during building.

An amount of a relief angle can be determined based on the combination of dimensions of the feedstock, compression, and acoustic-energy input and calculated appropriate tooling surface (e.g., the surface 603) length and width. In a specific exemplary embodiment of the design of the tool-tip geometries 600, 620, the outside dimension, Ø¬¬1, Ø¬¬3, of the tool (e.g., the tool tip 601) is about 3.15 mm, the inside dimension, Ø¬¬2, Ø¬¬4, of the tool is about 0.45 mm, and the side relieve angle, θ1, (e.g., the relief angle 605) is about 70 degrees (off-tool axial-direction). A tooling lateral width (D1, orthogonal to the tool-advance direction) is about 1.5 mm. These exemplary dimensions and angles are provided merely as examples to produce a tooling surface with a desired geometry to for a voxel of a desired-dimension range.

Additionally, a chamfer/fillet on the internal edge of the tool can be used to avoid forming stress concentrating features on the deposited voxel that can lead to feedstock breakage during a build. The chamfer/fillet size can be determined by comparing the dimensions of the feedstock, compression, and acoustic-energy input and calculated appropriate tooling surface length and width. In a specific exemplary embodiment of a tooling design, the chamfer D2, D3, is chosen to be about 0.15 mm. These exemplary dimensions and angles are provided merely as examples to produce a tooling surface with a desired geometry to for a voxel of a desired-dimension range.

Controlled Voxel Compression and/or Acoustic Power Input to Achieve Print Transition, Feedstock Termination, and Selective Interface Weakening

The range of process parameter values such as compression rate, compression amount, and acoustic-power input has an impact on the deformation and resulting dimension of the metal (or other material) being compressed under the tool. Compression rate, specifically, can be used as a number of process controls for print transition and termination of feedstock material. In one exemplary embodiment, when the deposition of metal is desired to end at one X, Y, and Z location and begins elsewhere, if the feedstock was not terminated at location 1, there could be a free-standing wire between the two locations once a voxel has been deposited at location 2. This free-standing wire can pose a number of process issues. To address this issue, the compression amount of the deposition of voxel at location 1 can be increased by, for example, about 50% to about 80% such that the wire feedstock is terminated once the tool is lifted away from voxel 1. This increase in compression is achieved by increasing tool displacement and therefore the tooling surface movement towards the bottom surface of the voxel being deposited such that lateral material-flow below the tool during extra compression behaves as if a cutting process is taking place. Similar feedstock termination can also be achieved by increasing the acoustic-energy input during the increased voxel compression amount.

Reversing the changes in the amount of voxel compression also results in changes in the strength of the interface joint. At a fixed acoustic-power input, increasing compression amount increases joint strength, while decreases in compression amount in a voxel during deposition result in lowering the joint strength to the previous layer. This change can be harnessed to selectively reduce the interfacial joint strength at a specific location in the build. One example of such locations is the part-support structure interface. When this specific interface is weak, during the support structure removal step of the post-fabrication process removal of support structure from the built part becomes easy and the attachment points on the part surface can remain clean and debris free. This process can be accomplished by changing the “support top gap” (or similar) settings such that a “gap” is used between a support structure and the section of the part surface to be supported. This gap setting can be between, for example, about 20% to about 80% of the layer height of a build, depending on material and feedstock size. Though referred to as a “gap,” it actually results in lower amounts of compression at that location when a voxel is being deposited, instead of leaving a physical gap in between. As a result of the reduced compression at the support-part interface, the resulting interface is weakened to a point that it is strong enough to still be attached to the part and provide physical support, but weak enough that in the support removal step the interface fractures before the support structure itself does.

FIG. 7 shows an example of an additive-manufacturing system 700 in accordance with various embodiments. The additive-manufacturing system 700 is shown to include a z-axis drive motor 709, a y-axis drive motor 711, an x-axis drive motor 713, a 3D-printing enclosure chamber 701, a 3D-print drive-circuit 705, and a power source 707. An acoustic-energy source 703 is coupled directly to the DAED tool 113. The 3D-print drive-circuit 705 may comprise any suitable electronic components, for example microprocessors, resistors, capacitors, inductors, transistors, diodes, light-emitting diodes, switches, traces, jumpers, fuses, amplifiers, antennas, and so forth, in order to control operation of the additive-manufacturing system 700. In some exemplary embodiments, the additive-manufacturing system 700 is controllable via a link to a software program operative on a personal computer, tablet, or other standalone control platform.

A 3D object (e.g., a component or a part) may be printed by the DAED tool 113 directly on the surface plate 111 or onto another object or other substrate mounted to the surface plate 111. Although shown in an exemplary configuration, the skilled artisan will recognize, upon reading and understanding the disclosure provided herein, that many different configurations are possible.

Overall, the z-axis drive motor 709, the y-axis drive motor 711, and the x-axis drive motor 713 provide three separate axes in which the combination of the acoustic-energy source 703 and the DAED tool 113. Additionally, and although not shown but readily understandable to a skilled artisan, additional degrees-of-freedom can be added to the combination of the acoustic-energy source 703 and the DAED tool 113. For example, a rotary-drive mechanism and a angular-drive mechanism may be added either to the combination of the acoustic-energy source 703 and the DAED tool 113 or the surface plate 111, or both. Therefore, either the combination of the acoustic-energy source 703 and the DAED tool 113 or the surface plate, or both, may either be fixed in place or may be translatable and/or rotatable in the x, y, and z directions, and various rotational angles. However, any suitable components or systems for translation, rotation, and/or other movement of relevant portions of the additive-manufacturing system 700 are considered to be within a scope of the present disclosure.

The 3D-print drive-circuit 705 can also be configured to store computer-aided design (CAD) or computer-aided manufacturing (CAM) files of various components or parts that can be formed or otherwise deposited by the DAED tool 113. The 3D-print drive-circuit 705 can prepare components, parts, or perform repairs, according to the CAD or CAM files by driving and controlling the various mechanisms shown in the additive-manufacturing system 700 of FIG. 7. Such operations are known in the relevant art.

Additionally, the acoustic-energy source 703 may be mounted remotely from the DAED tool 113 and electrically coupled to the transducer 101 (see FIG. 1) of the DAED tool 113.

Therefore, as shown, the additive-manufacturing system 700 is provided merely as an example of a possible manufacturing system that utilizes the DAED tool 113 to form various components or parts. Additionally, the additive-manufacturing system 700 may be used to repair existing components or parts in addition to forming new components.

The skilled artisan will further recognize that there are no limitations on a physical size or dimensions of the additive-manufacturing system 700. Also, although FIG. 7 shows only a single one of the DAED tool 113, the additive-manufacturing system 700 can readily incorporate multiple DAED tools (even though only one tool is shown). Each of the additional DAED tools may be coupled to a separate drive system. Alternatively, more than one DAED tool may be coupled to the same drive system in order to, for example, form larger components or parts much more quickly. Additionally, multiple DAED tools (e.g., two or more) can be used to focus an acoustic beam at a given intersection within a material, thereby concentrating the effects of the acoustic energy at a given and specified location. This acoustic focusing can be especially useful in certain types of material repair operations. As noted elsewhere herein, surface repairs can be used on different existing material surfaces (and in the bulk) to repair defects, cracks, openings, and other undesirable or unwanted features of the existing structure.

In a specific exemplary embodiment, the acoustic-energy source 703 supplies acoustic energy to the DAED tool 113 at a frequency of 60 kHz. Acoustic energy source 212 may provide a desired amount of the acoustic energy, for example 5 watts, 10 watts, 15 watts, or a range of powers, that are selectable for a desired deposition rate or material. The acoustic energy applied to a filament of the material feedstock 109 (e.g., 300 μm diameter, 99.99% Al feedstock) to produce a voxel is modulated, for example, through a selected frequency, at a selected amplitude, for a given and time. In addition to the acoustic-energy input modulation, the force with which the material feedstock 109 is compressed onto a substrate or existing layer can also be controlled by the 3D-print drive-circuit 705.

The DAED tool 113 may comprise geometries of a blade, a needle, a cylinder, a rectangle, a slab, or other suitable shape. The DAED tool 113 may be configured with any suitable dimensions and/or materials for a given operation. For example, an aspect ratio or other characteristic dimension or dimensions may be selected to achieve an amplitude of vibration of about 1 micron, responsive to an applied acoustic energy vibration of about 60 kHz applied to the DAED tool 113, at a free end of the DAED tool 113 that is in contact with a substrate or an existing layer of deposited material.

In a specific exemplary embodiment, the DAED tool 113 is configured with a width of about 3 mm and a length of between about 12 mm and about 25 mm. In another specific exemplary embodiment, the DAED tool 113 is configured with a width of about 2 mm and a length of about 12 mm. Moreover, the skilled artisan will appreciate, upon reading and understanding the disclosure provided herein, that various dimensions of the DAED tool 113 may be selected and/or adjusted as desired, for example, based on the dimensions of material in the material feedstock 109, an actual cross-sectional shape of the material, the type of material (e.g., elemental metals or alloys, polymers, various combinations of materials, etc., all based at least partially upon material properties and other physical characteristics of the material), and other factors as utilized in the additive-manufacturing system 700. In addition, one or more particular configurations and/or dimensions, shapes, etc. of the DAED tool 113 may be removed, replaced, or substituted from the additive-manufacturing system 700 and replaced with a different DAED tool 113 in order to accommodate different materials and/or achieve different properties for deposited materials.

In an exemplary embodiment, an operation of the additive-manufacturing system 700 begins by bringing the DAED tool 113 guiding the filament of the material feedstock 109 to a desired voxel location and holding the filament in place with nominal compressive pressure (for example, via operation of one or more of the drive motors, 709, 711, 713). As described above, the z-axis drive motor 709 can also be supplemented by or substituted for other types of linear actuators. Once positioned, the DAED tool 113 applies both compressive force and acoustic energy to the filament to soften the material of the filament as described in detail herein. The combination of the force applied by the DAED tool 113 and the application of acoustic energy to the filament allows the section of the filament defined by contact proximal to the filament and the DAED tool 113 to form (print) and subsequently bond one or more voxels onto a substrate or existing deposited layer. The aforementioned process may be repeated as necessary as the DAED tool 113 moves along a given axis until a desired track is completed (e.g., see FIG. 2 and the accompanying verbiage). In various examples, each voxel may overlap with a previous voxel and a subsequent voxel and with those in any adjacent tracks. The entire process may then be repeated for each track and for each layer, until a desired structure is formed. In various exemplary embodiments, the additive-manufacturing system 700 may achieve a target speed of build of, for example, about 0.2 mm³/second to about 1 mm³/second or higher, depending on input power, filament material, a number of the DAED tools employed, and other factors as described herein.

### Control of Microstructure

### Feed-Forward Control

As described above, the 3D printing process of the disclosed subject matter allows a user of the system to control a grain orientation and grain size. Consequently, the disclosed subject matter provides for a control of microstructure of printed voxels and tracks and the subsequent components or parts created by the voxels and tracks.

With continuing reference to FIG. 7, in an embodiment, the 3D-print drive-circuit 705 may be configured to store (e.g., in a non-volatile memory or other type of data storage media) a variety of lookup tables. The lookup tables contain data related to a predetermined microstructure based on a number of factors (variables). For example, Table I shows a specific exemplary embodiment of a dynamic lookup-table where changing one of the factors automatically changes the microstructure based on predetermined empirical data.

TABLE I

| | | Resulting RMS |
|---|---|---|
| | Value of | Roughness Value of |
| Factor | Factor | Microstructure [ [symbol] ] |
| Feedstock Material Flow Rate | To Be Input | [select spatial-bandwidth |
| [mm/sec] | | of related metrology tool |
| | | from drop-down menu] |
| DAED Tool Travel Rate Relative | To Be Input | |
| to Substrate/Layer [mm/sec] | | |
| Feedstock Material [select from | To Be Input | |
| drop-down menu] | | |
| Acoustic Power [W] | To Be Input | |
| Acoustic Frequency [rad/sec] | To Be Input | |
| Ambient Environment | | |
| Relative Pressure [kPa] | To Be Input | |
| Fluid Medium [select from drop- | To Be Input | |
| down menu] | | |
| Ambient Temperature [K] | To Be Input | |

As shown in the specific exemplary embodiment of the lookup table, values of the various factors can be entered, and a resulting RMS-roughness value of the microstructure will be displayed. For example, a “Fluid Medium” drop-down menu is shown since the disclosed subject matter can function in a wide range of environments. In one specific example, the DAED tool 113 (see FIG. 1) can be operated to form components or parts, or to repair existing structures (e.g., repair to micro-cracks in a hull of a ship) while the tool operates underwater. Since a resulting microstructure may have a different RMS-roughness value when used underwater, a new predetermined value may be entered into the lookup table to account for such environments.

In this example, the RMS-roughness can be stored, from the predetermined empirical measurements, as a power-spectral density function that is spatially-bandwidth dependent, to replicate a variety of roughness measurement tools including, for example, atomic force microscopy, optical profilometry, mechanical profilometry, Nomarski (differential interference contrast) microscopy, and other tools known in the metrological arts. The person of ordinary skill in the art will recognize that a number of other values may be displayed other than a roughness value. Although not all values may be needed for an expected operational use of the disclosed subject matter, the various embodiments described herein are capable of being utilized in a wide variety of contexts, including additional contexts not described explicitly herein.

Once the desired factors are entered, or, alternatively, previously stored for a known operation, the 3D-print drive-circuit 705 can prepare components, parts, or perform repairs, by driving and controlling the various mechanisms shown in the additive-manufacturing system 700 of FIG. 7.

### In-Process Thermal Annealing of Interfaces in DAED

In various applications, the voxel-by-voxel, layer-by-layer deposition of metal in the DAED technique described herein may cause high crystalline defects to accumulate in the interface regions. These crystalline defects are typically stacking faults and vacancy clusters. However, when not mitigated, the accumulation of these defects, as stacking of voxels and layers continues, can occur. The accumulation of these defects can result in larger-scale defects that may eventually lead to, for example, fracturing or separation of interfaces in the build material.

To circumvent these problems due to defects, low-grade heat can be introduced into the build material to elevate the temperature of the build material to below, for example, approximately one-third of the melting temperature of the material. For example, when using aluminum alloys, about 150° C. to about 180° C. would be an appropriate amount of low-grade heat to be added into the build material. As the temperature of the build material is elevated, the crystalline defects in the interface regions become mobile and can go through recovery via crystalline defect annihilation processes to reduce the defect density in these regions. A result is that these interface regions can obtain properties similar to that of the bulk region and fracture of interfaces and failure of builds can be avoided. Further, taking care of the interfaces in the manner described herein as a part is formed allows for higher structures (e.g., in a z-direction) with possible overhanging features being formed.

Various methods of introducing low-grade heat of several types, either prior to or after deposition by the DAED tool 113 of FIG. 1 can be used. The various methods of introducing low-grade heat can be of several types such as, for example, one or more of conductive, convective, and non-contact methods (such as radiative heating or inductive heating). For example, in a conductive mode, the surface plate 111 can be heated by conductive heating using conventional methods, such as a heating element including cartridge heaters or heating tapes. The heat is then transported through the surface plate 111 into a part being built (of a selected material or materials) by the addition of material layers. The temperature of the material is raised by the conductive heating to a desired temperature range. In an embodiment of a convective heating method, hot air or other hot fluids can be used to heat up the material.

In a radiative heating method, a heater (e.g., an infrared (IR) heater) can be used to radiate heat directly onto the material to affect a rise in a temperature of the material feedstock to a desired temperature range. For example, in inductive heating, a coil can be used to cause internal joule heating in the material via an alternating field imposed by the coil. Upon reading and understanding the disclosed subject matter, a person of ordinary skill in the art will recognize than one or more of the heating methods disclosed herein may be used on different components within the additive-manufacturing system 700 (see FIG. 7). For example, in various embodiments, a conductive heating element may be applied to the material feedstock 109.

As noted above, another method of introducing heat into the build material is through in-process heating of the material feedstock 109 (e.g., a metal wire/filament) itself during deposition. Heating of the material feedstock 109 allows the same annealing process to occur in the filament (e.g., wire) just prior to and during the deposition step. Once during deposition, as the material feedstock 109 is being deposited the heated filament transmits heat into the newly formed interface, heating it up. The added heat allows for the aforementioned crystalline defect annihilation and material recovery process to occur in the newly formed interface, thereby effectively reducing the crystalline defect density in the interface regions during the build process.

Heating the material feedstock 109 can also be accomplished using one or more of the same conductive, conductive, or non-contact methods described above. Since the material feedstock 109 in the DAED tool 113 and DAED technique is in direct contact with the DAED tool through which the acoustic energy is coupled through, as described above, the conduction method may less effective and could have a negative effect on the resonance and process input window under certain conditions. In the convective, radiative, and inductive methods, the material feedstock 109 can be heated prior to its entrance into the acoustic-energy coupling tool where the acoustic energy is coupled. This heating can prevent unwanted heating of the DAED tool 113.

Depending on the type of materials used, each of the conductive, convective, and non-contact methods may be more effective than others. For aluminum, and parts with smaller z-height in the build direction, heating through the surface plate 111 may provide more flexibility of, and less complexity, in the hardware set up of an additive-manufacturing system.

Overall, as is known to a person of ordinary skill in the art, the Hall-Petch (HP) equation, given by equation (10), below, relates grain size to the toughness of a metal by strengthening grain boundaries. The HP equation indicates that the strength of a metal is equal to the frictional stress plus a factor, k, a material-specific strengthening coefficient, times the inverse of the square root of the grain size, D, where D is a characteristic dimension of the grain. Therefore, grain size reduction is known to increase the toughness of a metal. According to equation (10):

$${σ}_{o} = {σ}_{i} + \frac{k}{\sqrt{D}} \qquad ( 10 )$$

where σᵢ is a material constant for the starting stress for dislocation movement and σᵢ is the yield stress. Thus, as the grain size decreases, the yield stress increased.

In each of the microstructure development or forming scenarios described herein, the grains forming the microstructure can be deposited to form an isotropic or quasi-isotropic material. Isotropic materials are characterized by properties which are independent of a particular direction of the material. For example, grains may be formed that are substantially isotropically shaped, thereby producing a material with properties independent of direction in which the property is examined. Grain size generally develops as a function of acoustic energy density, although not necessarily in a monotonic relationship.

With continuing reference to the concepts of heat=treatment processes, a temperature rise in the acoustic-based processes described herein can be attributed to three heat sources: (1) the volumetric heat generation from large amounts of plastic deformation associated with the height, h, change in a filament during voxel formation; (2) the frictional heat generated due to the cyclic relative motion between the filament and the substrate (or an existing deposited surface); and (3) the cyclic shear deformation of voxel in a filament-axial direction.

The volumetric heat generation due to plastic deformation associated with the voxel height change can be evaluated by first calculating the mechanical work done during linear deformation as shown by equation (11):

$${W}_{p} = {\int }_{{h}_{o}}^{h} area \times {σ}_{y} \times δ h \qquad ( 11 )$$

where σ_{y}=ξKεₚⁿ is the flow stress, ξ is the softening factor due to the applied acoustic energy, &p is the plastic strain, and K and n are material constants. For example, for aluminum, K=155.65 MPa and n=0.2123. Assuming ξ=1, the total work for a voxel formation is Wₚ=0.01 Joules. For aluminum, researchers have shown that approximately 30% of plastic strain energy will dissipate as heat while the remainder of the energy is stored in defects in the lattice. Consequently, the compressive strain in the voxel formation amounts to less than about 0.01 W of the volumetric heat generated during formation of an aluminum voxel, considering that in the exemplary embodiment considered, the voxel formation process takes place over about 300 milliseconds.

The second source of heat generation, Q_{f}, is the frictional heating from the relative movements between the voxel and the substrate or the voxel and the DAED tool 113. If the assumption is made that there is no slip between the DAED tool 113 and the voxel, this can be modeled as shown by equation (12):

$${Q}_{f} = μ FU \qquad ( 12 )$$

where μ is the coefficient of friction of the voxel-substrate contact, and U is the speed of the relative movement between the two surfaces. U can be approximated as U=4Af, where A is the amplitude of vibration, f is the frequency of vibration, and F is the contact force.

In an exemplary operation of additive-manufacturing systems of with aluminum, a metallurgical bond forms at approximately 30 microseconds into voxel formation when the contact force of the DAED tool 113 is about 10 N, the vibrational amplitude is about 0.98 microns, and the frequency is about 60 kHz. For an aluminum filament-aluminum substrate interface subjected to the 60 kHz ultrasound vibration, a friction coefficient of about 0.3 is assumed during voxel formation. Based on these values, the total frictional heat generation on the filament-substrate contact is calculated to be about 0.7 W.

The third component of heat generation takes place as the plastic strain due to the cyclic deformation in the voxel dissipates as volumetric heat. In an exemplary embodiment, the amplitude of vibration at the DAED tool 113-to-voxel contact is 0.98 microns; this is also the maximum displacement on the surface of a voxel at a given cycle of vibration. The resulting total shear strain during voxel formation varies from 0.33% to 0.83%. For the aluminum used in this exemplary embodiment, the strain above which the voxel enters plastic deformation is 0.13%). The amount of strain in each vibration cycle contributing to plastic strain heating, therefore, varies from 0.2% to 0.7%. Taking into account the 30% heat dissipation partition and the operating frequency of this exemplary ultrafine-microstructure (UFM) process, the average total heat generation due to cyclic plastic deformation during voxel formation is about 0.75 W.

For a fixed strain rate, the steady state is reached at a lower value of stress for compression deformation with higher simultaneous acoustic-energy density irradiation. It is therefore evident that more acoustic softening is achieved at higher input acoustic-energy densities during deformation. Also, the effect of acoustic energy is more pronounced at a higher strain rate. For a particular value of acoustic energy density, steady state is reached at a lower value of stresses at lower static compression strain rates. This means a lower static compression strain rates allows for higher amounts of acoustic softening.

To model the stress evolution during compression tests with simultaneous acoustic-energy irradiation, experimental data were used to determine several parameters in the KM model. Table II, below, summarizes the list of parameters obtained from references and the parameters determined using experimental data. Experimental data from one experiment (acoustic-energy density=434.35 J/m³ and strain rate=9.54 sec⁻¹) was used to predict evolution of dislocation density with strain.

TABLE II

| | | | Equation |
|---|---|---|---|
| | Parameter | Value | Number |
| Parameters | Pre-exponential Factor, \dot{γ}₀ [sec⁻¹] | 10⁶ | (1) |
| from | Shear Modulus, μ [MPa] | 26 × 10³ | (2), (3) |
| References | Burgers Vector, b [nm] | 0.286 | (3) |
| | Exponent in Equation (2), p | 3/4 | (2) |
| | Exponent in Equation (2), q | 4/3 | (2) |
| | Constant in Equation (3), a | 1/3 | (3) |
| | Activation Energy, Q_{d} [kJ/mol] | 144 | (6) |
| | Taylor Factor, M | 3.06 | (7) |
| Experimentally- | Coefficient in Equation (4), k₁ | 10,779.5 | (4) |
| Determined | Exponent in Equation (5), n | 3.4 | (5) |
| Parameters | Coefficient in Equation (5), k₂₀ | 22.48 | (5) |
| | Coefficient in Equation (8), \acute{γ}₀₀* | 0.705 | (6), (8) |
| | Exponent in Equation (8), χ | 10.05 | (8) |
| | [J/m³] | | |

Dislocation density values approach a steady state for larger values of strain. As discussed above, the steady state for dislocation density evolution is reached at a lower value of dislocation density for deformations with higher simultaneous acoustic energy input densities. This predicted dislocation density evolution is significantly different from the predicted dislocation-density evolution observed by other researchers.

Using curve fitting, k1 (of the athermal dislocation generation term in equation (4)), k₂ (of the strain rate and acoustic energy density dependent annihilation term in equation (4)), and the exponent n in equation (5) were determined. Since k₂ is an acoustic-energy dependent, values of k₂ for each acoustic-energy density value were determined. Constants k₂₀ in equation (5) and \acute{γ}₀₀ and χ in equation (8) were also determined using curve fitting. These constants were used in equations (1) through (8), above to find stress values for increasing strains. The stress versus strain curves were plotted for all compression experiments.

### Additional Uses of the Additive-Manufacturing Systems Described Herein

During service or during manufacturing, cracks often form on the surface of metal components, often due to cyclic loading. These cracks grow to cause faster failure of components or parts. Currently, fusion welding processes like Tungsten Inert Gas (TIG) are used to fill these cracks and thereby repair the surface of the components. These processes use heat energy, usually generated by an electric arc, to melt filler material and fill the crack. More recently, processes such as Laser Engineered Net Shaping (LENS), Laser Direct Metal Deposition (LMD), and Cold Spray have also been used for repairing cracks. The main disadvantage of these processes is that they create a large heat affected zone (HAZ) around the repaired crack because of the large amount of heat energy used to melt the filler material. Unlike the disclosed subject matter described herein, the added heat significantly alters the microstructure of components or parts in the HAZ. The technique described in this disclosure eliminates the aforementioned issues in the final product associated with thermal history and solidification.

As noted herein, the disclosed subject matter is a solid state, room temperature technique in which high-frequency, small amplitude local shear strains are used to achieve energy-efficient volumetric conformation of filler filament into a surface defect. Once the surface defect is filled, this technique also induces metallurgical bonding on filler-repair surface interfaces. This two-fold effect is similar to what heating and melting a filler metal does, but in this new technique no heat is used and both the filler and repaired surface remain solid at room (or ambient) temperatures the entire time. Further, the use of high-frequency, small amplitude oscillatory shear strain results in softening of the metal filler and allows it to “flow” and conform to the shape of the surface defects. Additionally, it also enables large amounts of material exchange at the interface to enable metallurgical bonding. Since the disclosed subject matter described herein uses no heat energy and causes a negligible temperature rise during the process, a microstructure of the component around the repaired region remains unaffected. This process can be used to repair metal components in various industries ranging from aerospace, maritime, and automotive industries to small-scale fabrication shops as is described in more detail, below.

As shown and described with regard to, for example, FIG. 7, above, various systems can perform surface repairs on, for example, metal components; a robotic arm with a surface repair tool head (e.g., the DAED tool 113 of FIG. 1) based on the technique described in this disclosure to perform in-place/in-situ repair of components or parts in service; the systems use surface vibrations to both (1) detect surface defects; and then (2) repair the defects. The concept and idea have been validated through two sets of experiments. Artificially created cracks in samples have been filled using the proposed process.

Overall, a person of ordinary skill in the art will appreciate that important aspects or characteristics of the additive-manufacturing operations of the DAED tool 113 (see FIG. 1) include (1) the mechanical stress, and therefore mechanical-energy input, used to “shape” the solid filament into a desired 3D geometry as the filament is reduced in the presence of applied acoustic (e.g., sonic or ultrasonic) energy as compared with the yield strength of the material; (2) the amount of mass transport across the inter-filament and inter-layer interfaces to form the various bonds (e.g., metallurgical bond in the case of a solid-metal filament) observed is more than 10,000 times higher than what the Fick's diffusion equation (known to a skilled artisan) predicts under the applied conditions; and (3) the temperature rise of the acoustic-energy process is nearly negligible, a reflection of the high coupling efficiency from acoustic energy input into the required plasticity and mass transport. These unique characteristics enable the acoustic-energy processes disclosed herein to be implemented within a desktop 3D printing environment, as well as within a high-precision, high-fidelity industrial additive-manufacturing setting.

Additionally, the unique nature of the additive-manufacturing operations of the DAED tool 113 can produce fully-dense metal and non-metal 3D printing at room (or ambient) temperature enables simultaneous printing of polymers and metals, a materials combination not feasible in melt-fuse-based metal-additive manufacturing processes. Further, the additive-manufacturing operations of the DAED tool 113 can control both grain size (microstructure) and grain orientation, as described herein. Also, as noted above, the various embodiments can readily be applied to various types of material-repair operations, even in less-manufacturing-friendly environments, such as underwater ship, submarine, or aerospace operations (including deep space environments) repair operations. The ability for the disclosed subject matter to operate in environments such as underwater, or alternatively, in the vacuum of space, is in stark contrast to thermal-diffusion processes of the prior art that relies on furnaces and other heat-generation mechanisms (often operating at hundreds or thousands of degrees Celsius) to change the structure of a material.

Furthermore, the athermal acoustic process described herein operate at the speed of sound in a given material, which can be at least three to four orders of magnitude higher than the prior art thermal processes, even after an appropriate amount of time has passed for the material to ramp up to the level of the furnaces and other thermal devices. Additionally, the acoustic process of the disclosed subject matter is far more energy efficient than thermal processes of the prior art. For example, a 1 W acoustic wave can deposit/repair material more quickly than a 1 MW thermal process of the prior art.

In various embodiments, the disclosed subject matter includes a variety of methods for deforming and depositing a feedstock material. A person of ordinary skill in the art, upon reading and understanding the disclosed subject matter, will recognize a number of different methods for deforming and depositing a feedstock material that have already been presented herein, or can readily be determined, with reference to the structure, operation, and design of the DAED tool. However, in one specific exemplary embodiment, an example of a method is shown and described in more detail.

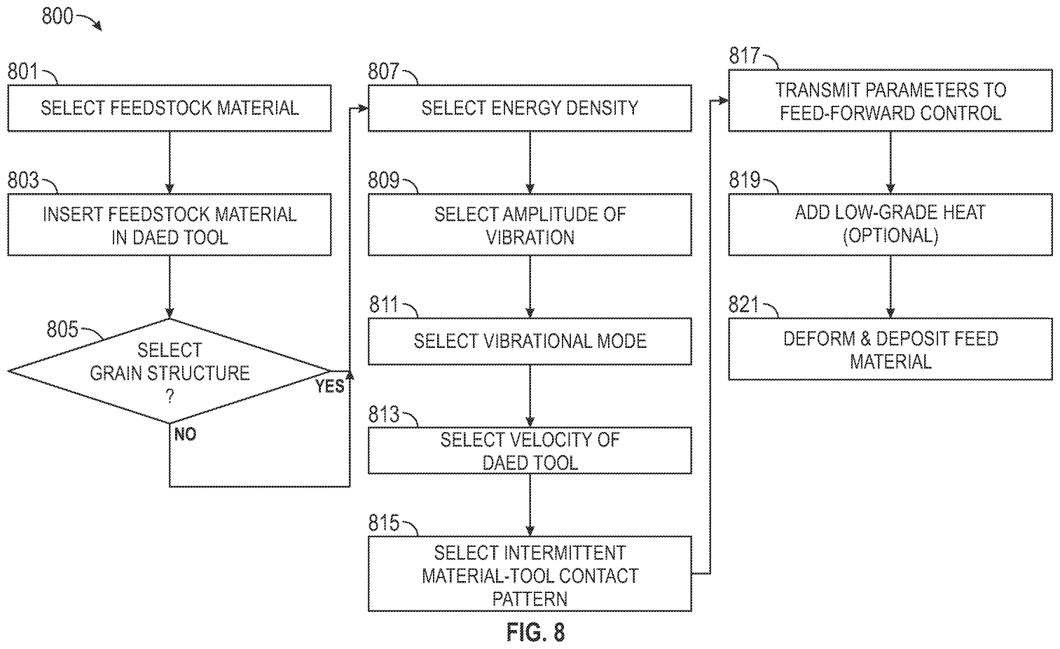

With reference to FIG. 8 that shows an exemplary embodiment of a method 800 for deforming and depositing a feedstock material, the method 800 includes, at operation 801, selecting the feedstock material, inserting the feedstock material into a Directed Acoustic Energy Deposition (DAED) tool at operation 803, and selecting at least one parameter to control the DAED tool. The selectable parameters include selecting an energy density at operation 807, selecting an amplitude of vibration at operation 809, selecting a vibrational mode at operation 811, and selecting a velocity of the DAED tool at operation 813. The selection of parameters however may not be required if all parameters are already stored in a database or look-up table and correlated to, for example, a specific feedstock material and/or a desired grain structure, for example, as shown at operation 805, for the selected feedstock material.

With concurrent reference to FIGS. 3A through 3D, at operation 815, the type of intermittent material-tool contact pattern 320, 340, 360, 380 is selected.

Once the parameters are selected, the parameters may be transmitted to, for example, a feed-forward control system, at operation 817, as described elsewhere herein. Optionally, at operation 819, low-grade heat may be added to one or more components in the system (e.g., to at least one of the DAED tool and the feedstock material) as discussed above. The feedstock material is then deformed and deposited, at operation 821, in accordance with the various descriptions and figures supplied herein.

The description above includes illustrative examples, devices, systems, and methods that embody the disclosed subject matter. In the description, for purposes of explanation, numerous specific details were set forth in order to provide an understanding of various embodiments of the disclosed subject matter. It will be evident, however, to those of ordinary skill in the art that various embodiments of the subject matter may be practiced without these specific details. Further, well-known structures, materials, and techniques have not been shown in detail, so as not to obscure the various illustrated embodiments.

As used herein, the term “or” may be construed in an inclusive or exclusive sense. Further, other embodiments will be understood by a person of ordinary skill in the art upon reading and understanding the disclosure provided. Further, upon reading and understanding the disclosure provided herein, the person of ordinary skill in the art will readily understand that various combinations of the techniques and examples provided herein may all be applied in various combinations.

Although various embodiments are discussed separately, these separate embodiments are not intended to be considered as independent techniques or designs. As indicated above, each of the various portions may be inter-related and each may be used separately or in combination with other portions or embodiments.

Consequently, many modifications and variations can be made, as will be apparent to the person of ordinary skill in the art upon reading and understanding the disclosure provided herein. Functionally equivalent methods and devices within the scope of the disclosure, in addition to those enumerated herein, will be apparent to the skilled artisan from the foregoing descriptions. Portions and features of some embodiments may be included in, or substituted for, those of others. Such modifications and variations are intended to fall within a scope of the appended claims. Therefore, the present disclosure is to be limited only by the terms of the appended claims, along with the full scope of equivalents to which such claims are entitled. It is also to be understood that the terminology used herein is for the purpose of describing particular embodiments only and is not intended to be limiting.

The Abstract of the Disclosure is provided to allow the reader to quickly ascertain the nature of the technical disclosure. The abstract is submitted with the understanding that it will not be used to interpret or limit the claims. In addition, in the foregoing Detailed Description, it may be seen that various features may be grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. An acoustic-energy deposition system to deposit material from a feedstock material, the system comprising:
at least one Directed Acoustic Energy Deposition (DAED) tool configured to apply acoustic energy to soften the feedstock material, the applied acoustic energy selected from at least one of three vibrational modes, the DAED configured to apply intermittent material-tool contact to form continuous depositions; and
a drive system to move the DAED tool in at least one of three-coordinate positions.

2. The acoustic-energy deposition system of claim 1, wherein the three vibrational modes include a first transverse mode in a first direction, a second transverse mode in a second direction that is substantially orthogonal to the first direction, and a longitudinal mode.

3. The acoustic-energy deposition system of claim 1, wherein the at least one of three vibrational modes is selected based on a crystalline structure of the feedstock material.

4. The acoustic-energy deposition system of claim 1, wherein the at least one of three vibrational modes is selected based on a material-type selection of the feedstock material.

5. The acoustic-energy deposition system of claim 1, wherein the feedstock material is selected from at least one material selected from materials including metals and polymers.

6. The acoustic-energy deposition system of claim 1, wherein the system, in one voxel deposition cycle, is configured to move by combining up, down, and lateral motions to produce a vertical voxel compression movement.

7. The acoustic-energy deposition system of claim 1, wherein the system, in one voxel deposition cycle, is configured to move by combining up, down, and lateral motions to produce an angled voxel compression movement with respect to the z-axis.

8. The acoustic-energy deposition system of claim 1, wherein the system, in one voxel deposition cycle, is configured to move by combining up, down, and lateral motions to produce an angled tooling lifting movement with respect to the z-axis.

9. The acoustic-energy deposition system of claim 1, wherein the system, in one voxel deposition cycle, is configured to move by combining up, down, and lateral motions to produce an angled tooling lifting movement and voxel compression movement with respect to the z-axis.

10. A system to deposit material from a feedstock material while operating in a three-dimensional tool path, the system comprising:
a print head that is movable in one or more dimension and to feed a solid-metal wire to form subsequently each layer of a three-dimensional structure, the metal voxel being formed from the solid-metal wire, the print head being configured to apply intermittent material-tool contact to form at least one form of deposition type selected from continuous depositions and step-and-print depositions.

11. The system of claim 10, wherein the system, in one voxel deposition cycle, is configured to move by combining up, down, and lateral motions to produce a vertical voxel compression movement 1.

12. A Directed Acoustic Energy Deposition (DAED) tool configured to apply ultrasonic acoustic-energy to deform and deposit a feedstock material; the DAED tool comprising:
an acoustic-energy coupling tool to deform, substantially athermally, the feedstock material based on a selected vibrational mode of the acoustic-energy coupling tool while the acoustic-energy coupling tool is at least partially in contact with the feedstock material, the DAED tool being configured to apply intermittent material-tool contact to form at least one form of deposition type selected from continuous depositions and step-and-print depositions; and
a transducer configured to produce the ultrasonic acoustic-energy to be applied to the acoustic-energy coupling tool.

13. The DAED tool of claim 12, further comprising a test plate to measure uniaxial compression loading from the acoustic-energy coupling tool exerted upon the material feedstock.

14. The DAED tool of claim 12, further comprising a feed-forward control system to direct the DAED tool in at least one of three-coordinate positions.

15. The DAED tool of claim 14, further comprising a look-up table to be coupled to the feed-forward control system, the look-up table including, for each of the feedstock materials to be deposited, pre-determined grain structures for each of a plurality of variables including energy density, amplitude, frequency, and velocity of the DAED tool for a desired grain microstructure.

16. The DAED tool of claim 12, wherein the transducer is configured to supply the ultrasonic acoustic-energy to the acoustic-energy coupling tool with at least one frequency selected from a frequency range of between about 5 kHz and about 350 kHz.

17. The DAED tool of claim 12, wherein the transducer is configured to supply the ultrasonic acoustic-energy to the acoustic-energy coupling tool with at least one frequency selected from a frequency range of between about 5 kHz and about 60 kHz.

18. The DAED tool of claim 12, wherein the transducer is configured to supply the ultrasonic acoustic-energy to the acoustic-energy coupling tool with at least one frequency selected from a frequency range of between about 60 kHz and about 180 kHz.

19. The DAED tool of claim 12, wherein the transducer is configured to supply the ultrasonic acoustic-energy to the acoustic-energy coupling tool with at least one power level selected from power levels including 5 watts, 10 watts, and 15 watts.

20. The DAED tool of claim 12, wherein the transducer is configured to supply the ultrasonic acoustic-energy to the acoustic-energy coupling tool with small-amplitude vibrations of about 0.5 micrometers to about 2 micrometers to be applied to the material feedstock.

21. The DAED tool of claim 12, wherein the selection of the vibrational mode includes a first transverse mode in a first direction, a second transverse mode in a second direction that is substantially orthogonal to the first direction, and a longitudinal mode.

22. The DAED tool of claim 12, wherein the DAED tool is configured to perform an in-situ repair of one or more components.

23. The DAED tool of claim 12, further comprising a heating element to provide low-grade heat to at least one portion of the DAED tool or the feedstock material.

24. The DAED tool of claim 23, wherein the low-grade heat is configured to provide approximately one-third of the melting temperature of the material to the feedstock material.

25. At least one Directed Acoustic Energy Deposition (DAED) tool configured to deform and deposit a feedstock material; each of the at least one DAED tool comprising:
an acoustic-energy coupling tool to deform, substantially athermally, the feedstock material based on a selected vibrational mode of the acoustic-energy coupling tool while the acoustic-energy coupling tool is at least partially in contact with the feedstock material;
a transducer configured to produce an ultrasonic acoustic-energy signal to be applied to the acoustic-energy coupling tool;
a coupling horn disposed between the transducer and the acoustic-energy coupling tool to couple and amplify the ultrasonic acoustic-energy signal produced by the transducer; and
a feed-forward control to apply one or more changes to the at least one DAED tool, the one or more changes selected from changes in at least one of energy density, an amplitude of the ultrasonic acoustic-energy signal, and a frequency of the applied acoustic signal to effect a plastic change in the feedstock material, the DAED tool being configured to apply intermittent material-tool contact to form at least one form of deposition type selected from continuous depositions and step-and-print depositions.

26. The at least one DAED tool of claim 25, wherein the feed-forward control is further configured to control changes of a microstructure of the deformed and deposited feedstock material within a proximity of the acoustic-energy coupling tool.

27. The at least one DAED tool of claim 25, wherein the DAED tool is configured to soften the feedstock material beyond an elastic region of the material and plasticly deform the feedstock material, thereby extruding the feedstock material

28. The at least one DAED tool of claim 25, wherein the transducer is configured to convert an alternating current (AC) signal into the ultrasonic acoustic-energy signal.

29. The at least one DAED tool of claim 25, further comprising a drive system to move the DAED tool in at least one of three-coordinate positions.

30. The at least one DAED tool of claim 25, wherein the DAED tool, in one voxel deposition cycle, is configured to move by combining up, down, and lateral motions to produce a vertical voxel compression movement.

31. The at least one DAED tool of claim 25, wherein the DAED tool is configured to deform and deposit the feedstock material into a plurality of tracks of deposited material.

32. The at least one DAED tool of claim 25, wherein the DAED tool is configured to deform and deposit the feedstock material into a plurality of voxels of deposited material.

33. A method for deforming and depositing a feedstock material, the method comprising:
selecting the feedstock material;
inserting the feedstock material into a Directed Acoustic Energy Deposition (DAED) tool;
selecting at least one parameter to control the DAED tool from parameters including selecting an energy density; selecting an amplitude of vibration, selecting a vibrational mode, and selecting a velocity of the DAED tool;
introducing intermittent material-tool contact to apply intermittent material-tool contact to form at least one form of deposition type selected from continuous depositions and step-and-print depositions; and
deforming and depositing the feedstock material.

34. The method of claim 33, further comprising selecting a grain structure for the deposited feedstock material.

35. The method of claim 33, further comprising transmitting the at least one parameter to control the DAED tool to a feed-forward control system.

36. The method of claim 33, further comprising adding low-grade heat to at least one of the DAED tool and the feedstock material.
